(19) United States
(12) Patent Application Publication
(10) Pub. No.: US 2016/0070022 A1
(43) Pub. Date: Mar. 10, 2016

(54) FAST SCINTILLATION HIGH DENSITY OXIDE AND OXY-FLUORIDE GLASS AND NANO-STRUCTURED MATERIALS FOR WELL LOGGING APPLICATIONS

(71) Applicants: Valery N. Khabashesku, Houston, TX (US); Maxim Vasilyev, The Woodlands, TX (US); Evgeniy Tretyak, Minsk (BY); Andrei Fedorov, Minsk (BY); Mikhail Korjik, Minsk (BY)

(72) Inventors: Valery N. Khabashesku, Houston, TX (US); Maxim Vasilyev, The Woodlands, TX (US); Evgeniy Tretyak, Minsk (BY); Andrei Fedorov, Minsk (BY); Mikhail Korjik, Minsk (BY)

(73) Assignee: BAKER HUGHES INCORPORATED, Houston, TX (US)

(21) Appl. No.: 14/932,691

(22) Filed: Nov. 4, 2015

Related U.S. Application Data
(63) Continuation-in-part of application No. 14/484,581, filed on Sep. 12, 2014.
(60) Provisional application No. 61/877,559, filed on Sep. 13, 2013.

(51) Int. Cl. G01V 5/06; G01V 13/00; E21B 49/00

(52) U.S. Cl. CPC G01V 5/06; E21B 49/00; G01V 13/00

(57) ABSTRACT

An apparatus for estimating a property of an earth formation penetrated by a borehole includes: a carrier configured to be conveyed through the borehole and a gamma-ray detector disposed on the carrier and comprising a scintillation material. The scintillation material includes a barium silicate glass or glass ceramic transparent to light doped with Ce and containing ions of elements with atomic numbers greater than or equal to 55, and having a density greater than 4.5 g/cm³. The apparatus further includes a photodetector optically coupled to the scintillation material and configured to detect light photons emitted from the scintillation and to provide a signal correlated to the detected light photons and a processor configured to estimate the property using the signal.

### CROSS REFERENCE TO RELATED APPLICATIONS

This application is a continuation in part of U.S. Non-Provisional application Ser. No. 14/484,581 filed Sep. 12, 2014 which claims benefit of U.S. Provisional Application Ser. No. 61/877,559 filed Sep. 13, 2013, the entire disclosure of which is incorporated herein by reference.

### BACKGROUND

Geologic formations are used for many purposes such as hydrocarbon production, geothermal production and carbon dioxide sequestration. In general, formations are characterized in order to determine if the formations are suitable for their intended purpose.

One way to characterize a formation is to convey a downhole tool through a borehole penetrating the formation. The tool is configured to perform measurements of one or more properties of the formation at various depths in the borehole to create a measurement log.

Many types of logs can be used to characterize a formation. In one type of log referred to as a natural gamma ray log, a gamma ray detector is disposed in a downhole tool. As the downhole tool is conveyed through the borehole, the gamma ray detector detects natural gamma rays emitted from the formation. The detector response is recorded and analyzed. From the energy peaks displayed from the detector response, the presence of certain minerals in the formation can be determined. In another type of downhole tool, a gamma ray detector is configured to detect gamma rays resulting from irradiating the formation with neutrons in order to estimate formation density or porosity. It can be appreciated that improving the sensitivity of the gamma-ray detector can improve the accuracy of the formation characterization.

### BRIEF SUMMARY

Disclosed is an apparatus for estimating a property of an earth formation penetrated by a borehole. The apparatus includes: a carrier configured to be conveyed through the borehole; a gamma-ray detector disposed on the carrier and comprising a scintillation material, the scintillation material comprising a barium silicate glass or glass ceramic transparent to light doped with Ce and containing ions of elements with atomic numbers greater than or equal to 55, and having a density greater than 4.5 g/cm³; a photodetector optically coupled to the scintillation material and configured to detect light photons emitted from the scintillation and to provide a signal correlated to the detected light photons; and a processor configured to estimate the property using the signal.

Also disclosed is a method for estimating a property of an earth formation penetrated by a borehole. The method includes: conveying a carrier through the borehole; receiving gamma-rays from the formation using a gamma-ray detector, the gamma-ray detector comprising a scintillation material comprising a barium silicate glass or glass ceramic transparent to light doped with Ce and containing ions of elements with atomic numbers greater than or equal to 55, and having a density greater than 4.5 g/cm³; detecting light photons emitted by scintillation of the scintillation material using a photodetector to produce a signal correlated to the detected light photons; and estimating the property using a processor that receives the signal.

Further disclosed is a method for producing an apparatus for estimating a property of an earth formation penetrated by a borehole. The method includes: producing a scintillation material by heating a mixture of a barium silicate glass transparent to light and doped with Ce and rare earth ions of elements with atomic numbers greater than or equal to 55 according to a temperature profile of temperature versus time, the temperature profile comprising (a) a first stage having a first plateau at a vitrification temperature (T_{g}) of the mixture followed by a second plateau at a temperature (T_{P}) higher than T_{g} but lower than the avalanche crystallization temperature of the barium silicate glass and (b) a second stage following the first stage at a room temperature and having a third plateau at a temperature (T_{C}) that is higher than T_{g} but lower than the avalanche crystallization temperature of the barium silicate glass to produce a barium silicate glass and/or glass ceramic, the scintillation material having a density greater than 4.5 g/cm³; incorporating the scintillation material into a gamma-ray detector; optically coupling a photodetector to the scintillation material, the photodetector configured to detect light photons emitted from scintillation of the scintillation material and to provide a signal correlated to the detected light photons; coupling the photodetector to a processor configured to estimate the property using the signal; and coupling the gamma-ray detector to a carrier configured to be conveyed through the borehole.

### BRIEF DESCRIPTION OF THE DRAWINGS

The following descriptions should not be considered limiting in any way. With reference to the accompanying drawings, like elements are numbered alike:

FIG. 1 illustrates an exemplary embodiment of a downhole tool having a gamma ray detector disposed in a borehole penetrating the earth;

FIG. 2 depicts aspects of a schematic structure of nano-crystallite gamma ray detection material disposed in the gamma ray detector;

FIG. 3 depicts aspects of a first temperature program for synthesizing nano-crystallites in the gamma ray detection material;

FIG. 4 depicts aspects of a second temperature program for synthesizing nano-crystallites in the gamma ray detection material;

FIG. 5 is a flow chart of a method for estimating a property of an earth formation;

FIG. 6 is a phase diagram of a BaO—SiO2 system;

FIG. 7 illustrates room temperature luminescence (solid line) at excitation 370 nm and excitation 330 nm (dotted line) of the glass worked from composition of BaO and SiO₂ with molar ratio 2:3 with addition of CeO₂ as an excess to composition;

FIG. 8 illustrates comparison of amplitude spectra of ¹³⁷Cs source (662 keV) measured with glass made from two different compositions;

FIG. 9 illustrates luminescence and luminescence excitation spectra of glass having 2BaF₂.3SiO₂.2GdF₃.SiO₂.CeF₃;

FIG. 10 depicts aspects of nano-structured glass ceramics having scintillating nano-objects and non-scintillating nano-objects distributed in the glass along with ions of Ce activator in the glass, in the scintillating nano-objects, and in the non-scintillating nano-objects;

FIG. 11 illustrates an amplitude spectrum of ¹³⁷Ce source (662 keV) measured with a sample of nano-structured glass ceramics sample having 2BaF₂.3SiO₂.2GdF₃.SiO₂.CeF₃ obtained after annealing of the glass sample;

FIG. 12 is a flow chart for a method for estimating a property of an earth formation penetrated by a borehole; and

FIG. 13 is a flow chart for a method for producing an apparatus for estimating a property of an earth formation penetrated by a borehole.

### DETAILED DESCRIPTION

Disclosed are apparatus and method for detecting gamma-rays in a downhole tool with improved sensitivity and, hence, accuracy. In one or more embodiments, gamma-rays detected during well logging operations are used to estimate a property of an earth formation such as density, porosity, or mineral composition using processing techniques known in the art.

A detailed description of one or more embodiments of the disclosed apparatus and method presented herein by way of exemplification and not limitation with reference to the Figures.

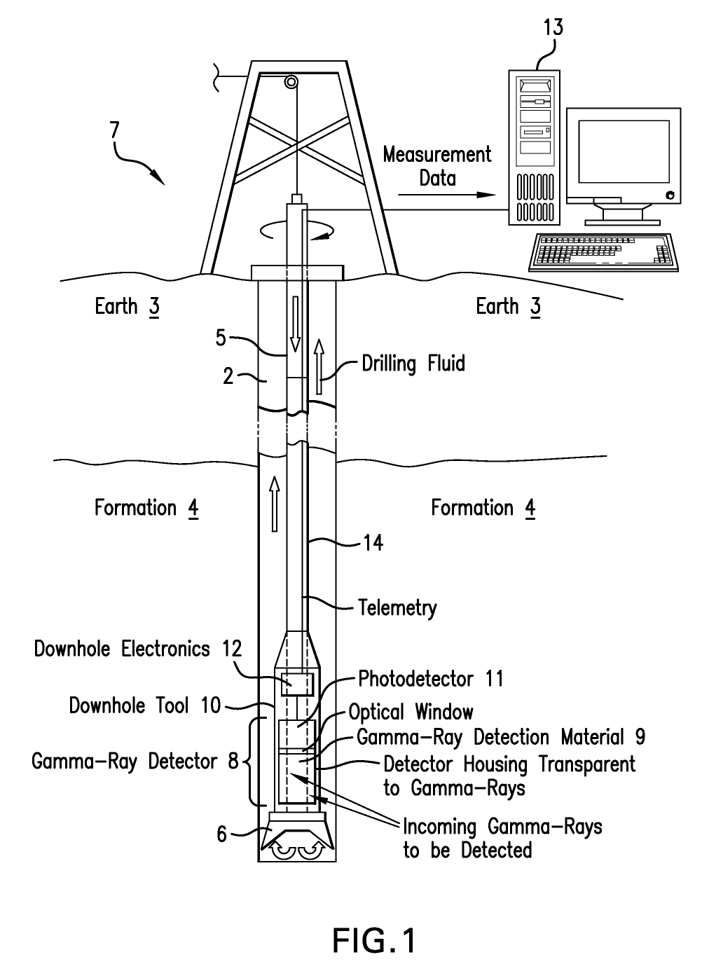

FIG. 1 illustrates an exemplary embodiment of a downhole tool 10 disposed in a borehole 2 penetrating the earth 3, which includes an earth formation 4. The formation 4 represents any subsurface materials of interest. The downhole tool 10 is conveyed through the borehole 2 by a carrier 14. In the embodiment of FIG. 1, the carrier 14 is a drill string 5. Disposed at the distal end of the drill string 5 is a drill bit 6. A drilling rig 7 is configured to conduct drilling operations such as rotating the drill string 5 and thus the drill bit 6 in order to drill the borehole 2. In addition, the drill rig 7 is configured to pump drilling fluid through the drill string 5 in order to lubricate the drill bit 6 and flush cuttings from the borehole 2. The downhole tool 10 is configured to perform formation measurements while the borehole 2 is being drilling or during a temporary halt in drilling in an application referred to as logging-while-drilling (LWD). In an alternative logging application referred to as wireline logging, the carrier 14 is an armored wireline configured to convey the downhole tool 10 through the borehole 2.

Still referring to FIG. 1, the downhole tool 10 includes a gamma-ray detector 8 that is configured to detect gamma-rays emitted by the formation 4. The gamma-ray detector 8 includes a gamma-ray detection material 9 (also referred to as scintillation material) optically coupled to a photodetector 11. An optical window may be used as an interface between the gamma-ray detection material and the photodetector. A housing transparent to gamma-rays may be used to contain the gamma-ray detection material, the optical window and the photodetector. The gamma-ray detection material 9 is configured to interact with an incoming gamma-ray from the formation 4 to generate photons through a scintillation process. The photodetector 11 is configured to detect the generated photons and provide an electrical signal, such as pulses of current or voltage, having a characteristic that corresponds to a physical characteristic of the incoming photon. For example, output from the photodetector may be used to generate a count versus energy plot having one or more peaks, which correspond to one or more chemical elements. Hence, from the detection of the gamma-rays emitted from the formation, one of more properties, such as the chemical composition or presence of certain minerals, can be determined using an output signal from the gamma-ray detector as would be known to one of skill in the art. Non-limiting embodiments of the photodetector 11 include a photo-multiplier-tube (PMT) and a solid-state semiconductor device.

Still referring to FIG. 1, the gamma-ray detector 8 is coupled to downhole electronics 12. The downhole electronics 12 are configured to operate the downhole tool 10, process data from formation measurements, and/or provide an interface for transmitting data to a surface computer processing system 13 via a telemetry system. In one or more embodiments, the downhole electronics 12 can provide operating voltages to the gamma-ray detector 8 and measure or count electrical current or voltage pulses resulting from gamma-ray detection. Processing functions such as counting detected gamma-rays or determining a formation property can be performed by the downhole electronics 12, the surface computer processing system 13, or combination thereof. In one or more embodiments, the processing can include comparing the photodetector output to a reference in order to determine the formation property.

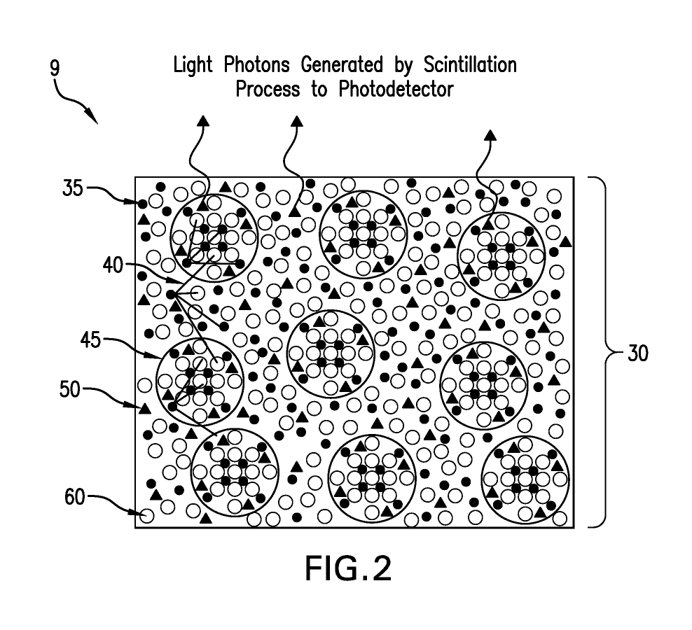

FIG. 2 depicts aspects of a schematic structure of the gamma-ray detection material 9. A plurality of nano-crystallites 45 is disposed in a glass matrix 30. The glass matrix is a material transparent to light and includes atoms 60 such as Al, Si, and O for example. Each nano-crystallite 45 has a periodic crystal lattice structure. Positions in the periodic crystal lattice structure are occupied by a heavy atom 35 and an activator atom 50 (note that there can be at least thousands of heavy atoms and hundreds of activator atoms in addition to light atoms inside a single nano-crystallite). For illustration purposes, the plurality of nano-crystallites 45 is depicted as having a spherical boundary whereas the nano-crystallites may have crystal-shaped boundaries. A diameter or dimension of each of the nano-crystallites 45 is generally in a range of about 100 nm to less than 1000 nm.

Detection efficiency of unit volume of a scintillation material to gamma radiation is influenced by the material's density and effective atomic number. High effective atomic number of a material is generally needed for gamma energies below 1 Mev, where photo-effect is a prevailing effect of gamma quanta interaction with media. For example, radioisotopes naturally occurring in a formation emit gamma-lines in a range from 0 to 3 MeV, and many of important gamma-lines have energies in a range below 1 Mev. NaI(Tl) scintillation single crystal is widely used in the industry for detection of gamma-rays. Its density of 3.67 g/cm³ and effective atomic number Zeff=50 provide a sufficient level of sensitivity (or counting efficiency) to gamma-radiation. To be competitive with NaI(Tl) in the industry, a scintillation material based on a glass or glass ceramic should have density greater than or equal to that of NaI(Tl). Since glass or glass ceramics unavoidably include such light elements as oxygen, they should also include elements with atomic number of at least 55 or higher to achieve competitive (or better) Zeff.

The heavy atom 35 has an atomic number greater than or equal to 55. The heavy atom 35 interacts with an incoming gamma-ray (also referred to as γ-quanta) and to emit a “hot” electron 40. The term “hot” relates to an electron or hole having an increase in energy that allows the energetic electron or hole to propagate or travel. The “hot” electron travels and interacts with the activator atom 50 to cause a scintillation process that results in generating a light photon. As discussed above, the generated light photon is detected by the photodetector 11. It can be appreciated that the higher the energy of the incoming γ-quanta (i.e., gamma-ray), the higher will be the total energy of the “hot” electrons that are emitted by the heavy atom 35 resulting in an increase in the number of light photons that are generated and detected. The increase in the number of photons detected will correspond to an increase in the signal or pulse level that is output by the photodetector 11. As illustrated in FIG. 2, the glass matrix 30 external to the nano-crystallites 45 includes heavy atoms 35 and activator atoms 50. In one or more embodiments, the heavy atoms 35 in both the nano-crystallites 45 and the glass matrix 30 external to the nano-crystallites 45 are of the same type (i.e., same element). Similarly, the activator atoms 50 in both the nano-crystallites 45 and the glass matrix 30 external to the nano-crystallites 45 are of the same type (i.e., same element). In alternative embodiments, more than one type of heavy atom 35 and/or activator atom 50 may be in the nano-crystallites 45 and/or the glass matrix 30.

It can be appreciated that the gamma-ray detector 8 having the nano-structured gamma-ray detection material 9 has improved energy conversion efficiency compared to prior art gamma-ray detectors. The improved efficiency is due to the presence of scintillating nano-crystallites 45 in the detector material which are formed in the detector glass body in the process of the controlled recrystallization of some fraction of its volume. Inside these scintillating nano-crystallites atoms form regular structure of crystal lattices, whereas atoms surrounding the nano-crystallites still are distributed randomly forming conventional amorphous (irregular) structure of glass. It is noted that these atoms inside scintillating nano crystallites include heavy atoms 35 and activator atoms 50. In an amorphous structure, only a small part of energy losses of “hot” electrons is converted into scintillation emissions due to inefficient energy transfer to activator atoms 50 and the main part of primarily absorbed energy of γ-quanta is lost ineffectively for material heating, without scintillation. In turn, when γ-quanta propagate inside the nano-crystallites and surrounding amorphous media they produce “hot” electrons 40, all energy losses of “hot” electrons at their interaction with atoms composing crystal lattice can be efficiently (from several to 100 times more efficiently than in an amorphous structure) delivered to activator atoms 50 via exciton mechanism of energy transfer.

Thus, i) placing activator atoms 50 inside scintillating nano-crystallites increase efficiency of the energy transfer from a “hot” electron to an activator atom due to exciton mechanism and ii) placing heavy atoms 35 inside scintillating nano objects increases number of “hot” electrons created by scintillation in the nano-crystallites, which compensates for the concentration of heavy atoms 35 in a detector material being relatively low, normally no more than 30 atomic %.

It is also noted that, depending on recrystallization process conditions, up to 80% of the total volume of the detector material 30 (i.e., glass matrix 30) may be transformed to the nano-crystallites without loss of optical transparency of the detector material. This also means that up to 80% of heavy atoms 35 and activator atoms 50 in the detector material are located inside the nano-crystallites.

Next, aspects of selecting activator atoms and scintillation material are discussed. As a rule, acceptable temperature dependence of the scintillation light yield versus temperature in the range from room to temperature to 200° C. is shown by doped scintillation materials. Examples of scintillation materials which possess such properties are single crystalline compounds activated by Ce³⁺ and Pr³⁺ ions. The scintillation process in these compounds is driven by the interconfiguration radiation transitions 5d→f (Ce³⁺) and 4f5d→f²(Pr³⁺) which have low yield (LY) temperature dependence up to 200° C. For example, such scintillation material as YAlO₃:Ce has a high LY parameter, fast scintillation process and its LY has minor change up to 100° C. Partial replacement of yttrium with lutetium decreases LY value but improves LY temperature dependence LY(T) making it stable up to 200° C. These materials have small effective charge Z_{eff} and are preferable for detection of “soft” (lower energy) γ-rays. Some Pr³⁺ doped materials show even better LY(T) dependence, for instance YAlO₃: Pr³⁺, but also has a small Z_{eff}. Scintillation crystal of lutetium aluminum garnet doped with Pr (Lu₃Al₃O₁₂:Pr or LuAG:Pr) demonstrates even growing dependence of LY(T) in the temperature range 50-170° C. At the same time, Lu contains substantial amount of naturally radioactive isotope which emits β-particles. This self-radiation background in the signal of the scintillation detector based on LAG:Pr makes it impossible to use such material in detectors to perform natural gamma ray well logging measurements. Better dependence of LY(T) at high temperatures (less decrease of LY with T increase) for scintillation materials activated by Pr³⁺ in comparison with scintillators based on the same matrix and activated by Ce³⁺ is due to faster kinetics of the interconfigurational radiative transitions. For Pr³⁺, it is about 2 times faster than for Ce³⁺. Due to this fact, the influence of non-radiative relaxations of the excited electronic states on the scintillation process is smaller in materials doped with Pr³⁺.

Composite nano-crystallite material overcomes disadvantages of single crystalline materials. In the composite nano-crystallite material, a favorable combination of heavy atoms in the glass matrix surrounding nano-crystallites also containing heavy atoms can be achieved. Here, main requirements of the nano-crystallites are as follows. First, they have to be nano-sized with dimensions smaller than wavelength of scintillation light to prevent scattering of the light inside the composite. In one or more embodiments, a diameter or dimension of each of the nano-crystallites is at least four times smaller than a wavelength of light emitted by the scintillation. Second, the nano-crystallites have to exhibit high light yield of scintillation, therefore they should be big enough and contain large number crystal lattice unit cells to provide effective exciton mechanism of energy transfer. In case when refractive index of the nano-crystallites is close to that of the glass matrix (which is generally the case when nano-crystallites are produced inside the glass matrix in the process of crystallization), the size of nano-crystallites can be large enough and even comparable with scintillation wavelength without worsening of optical transparency. Therefore, in one or more embodiments, the size of nanoparticles is in range of approximately 100 nm to less than 1000 nm to combine optical transparency with high scintillation efficiency.

Gamma quanta entering the composite nano-crystallite detection material undergo several mechanisms of interaction of gamma quanta with matter in the nano-crystallites. At the energies of gamma quanta below 1 MeV, the most important mechanism is photo-electric effect. With the photo-electric effect, the efficiency of gamma quanta absorption in matter is proportional to the effective atomic number of the matter in a degree varying exponentially from 4 to 5 depending on the energy in a range from 10 keV to 1 MeV (i.e. from Z⁴ to Z⁵).

Effective atomic numbers Z of the components forming the composite nano-crystallite detection material are distributed as follows: Z_{nano-crystallite heavy atoms}>Z_{nano-crystallite scintillator atoms}>Z_{light glass matrix atoms}. (Effective Z for a particular type of atom relates to averaging the atomic number for those types of atoms generally using 3.5 degree averaging in nuclear physics. For example, Z=root 3.5 [X^{3.5}+Y^{3.5}] for atoms X and Y) Due to this fact, the most probable photo-electric absorption of the gamma quanta will occur in the heavy atoms incorporated into the light glass matrix such as Pb, Bi, Ba, Hf, Au, I, and Pt for example and in the nano-crystallites containing the same heavy ions. Some of the hot electrons produced from this interaction will also be absorbed most probably in the heavy atoms incorporated into the light glass matrix such as the Pb, Bi, Ba, Hf, Au, I, and Pt and in the nano-crystallites containing the same heavy ions. However, the amount of hot electrons not absorbed by the heavy atoms is significant and, thus, will be effectively transformed into energy of light scintillation photons.

The “mother's” glass (i.e., the glass surrounding the nano-crystallites) should contain as large a number as possible of heavy atoms which provide high stopping power of γ-quanta by detector material. So nano-crystallites contain and are surrounded by atoms with high absorption to γ-quanta to allow a creation of a large quantity of hot electrons. This detection material is transparent to scintillation light produced by the nano-crystallites. To meet these requirements, heavy atoms such as Pb, Bi, Ba, Hf, Au, I, and Pt are inside the media surrounding the nano-crystallites (and inside the nano-crystallites). Transparency of the surrounding media to scintillation light can be achieved in ceramics, polymer and amorphous glass. Production of the transparent ceramics is an expensive process and limits an amount of possible combinations of host media and nano-crystallites by the requirement of the cubic symmetry of the species. Polymers generally allow the joining nanoparticles and heavy ions in a small quantities, and makes energy transfer between them low. (Also, there is no match of refractive indices of polymer and nano-crystallites due to density differences.) Glass matrix generally allows an infinite number of combinations of atoms. It allows production of transparent media where more than 50% of the atoms are heavy atoms. Another benefit of a glass matrix material with heavy atoms is that is has a high refractive index comparable with that of the nano-crystallites. Precise adjustment of the glass matrix refractive index to match that of the nano-crystallites is possible by variation of the number of heavy atoms in the glass matrix material. However, as disclosed herein the nano-crystallites produced by crystallization inside the glass matrix material inherently have matching refractive indices. While the glass matrix material has certain advantages, ceramics and polymers may also be used in other embodiments.

Next, processes to produce the nano-crystallites in the glass matrix material are discussed. After glass manufacturing to produce glass matrix material having the heavy atoms and the activator atoms, the glass undergoes a heat treatment process. In the heat treatment process, the glass is exposed to a temperature at T which is higher than glass vitrification temperature Tg, but less than the temperature of the avalanche crystallization, for an extended period of time. The main goal of this step is to form nano-crystallites in the glass matrix material.

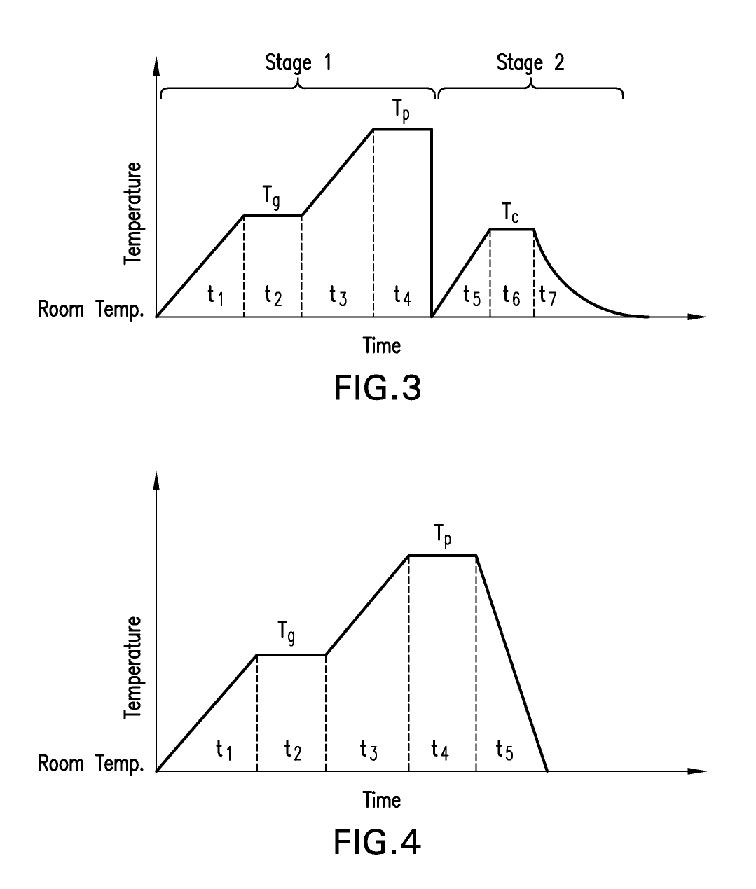

FIG. 3 depicts aspects of a first temperature program for synthesizing nano-crystallites in the glass matrix material. The synthesizing is generally performed using an oven to apply a temperature profile to glass matrix material. Referring to FIG. 3, stage 1 of the synthesis process involves melting the glass matrix material to form a homogeneous glass structure. It includes of several steps. During time period t1, the mixture is heated up to the temperature of vitrification Tg where different parts of the mixture start to smelt to each other and the mixture is kept at this temperature during time period t2 to outgas the material. The duration of t2 is different for different glasses and can vary from 0 to hundreds of hours depending on the glass mixture. During time period t3, the temperature of the material is increased up to the glass melting temperature Tp. The obtained glass melt is kept at this temperature during time period t4 for its homogenization and, after this it is cooled very rapidly at a cooling rate greater than 500° C./min to a temperature at or above room temperature.

The main goal of Stage 2 of the synthesis process in FIG. 3 is to create the nano-crystallites in the glass matrix material by annealing the glass obtained in Stage 1 at temperature Tp, which is higher than glass vitrification temperature Tg, but less than the temperature of the avalanche crystallization of the nano-crystallites. The temperature of the glass after stage 1 is slowly increased during time period t5. Then, the glass is annealed at constant temperature Tc during time period t6. Alternatively, the temperature Tc can be slowly increased during the recrystallization depending on the composition of ingredients in the glass system. The glass matrix material is then cooled to room temperature (generally within the oven) during time period t7.

Nano crystallites also can be obtained in the glass matrix material during stage 1 when glass melt is kept at temperature Tp during time period t4 for its homogenization and then cooled at a controlled cooling rate in the range 20-100° C./min to a temperature at or above room temperature as illustrated in time period t5 in FIG. 4.

A first example of producing the gamma-ray detection material 9 is now presented using the temperature program illustrated in FIG. 3. In this example, a composition 1:2 of chemicals BaO and SiO2 in mol. % and additive of 6 weight % of CeO₂ as an excess to BaO—SiO2 mixture is mixed and heated during time t1=10-60 min in the atmosphere to temperature Tg=480-520° C. and kept at this temperature for t2=1-20 min. The resulting glass is then heated during t3=10-60 min to Tp (1380-1450° C.), kept there for t4=60-1200 min, and then quenched in the mold with the temperature decrease rate of 300-600° C./min. Obtained glass has density of 3.7 g/cm³ and has effective charge Z_{eff} of the compound of 51 which is larger than effective Z_{eff} of NaI(Tl). Obtained glass is then heated during t5=10-60 min to temperature Tc=800-1000° C., kept at this temperature during t6=10-600 min, and cooled in the oven to a temperature at or above room temperature during time t7 (e.g., 30-600 min). This process results in nano-crystallites of barium disilicate, BaSi2O5, containing Ce3+ ions being distributed throughout the glass matrix 30. An indication of the presence of the nano-crystallites is a rise of a strong luminescence band in blue-green region. The Ce³⁺ ions in the barium disilicate have strong luminescence in the blue green region peaked at 480 μm.

In a case when Eu is used as activator atoms, Stage 1 is performed in a reducing atmosphere created in the flame at the burning of the mixture of natural gas and air. This process results in the formation of nano-crystallites of barium disilicate, BaSi2O5, containing Eu²⁺ ions in the glass matrix material. An indication of the presence of the nano-crystallites having Eu²⁺ is a rise of a strong luminescence band in green region. The Eu²⁺ ions in the barium disilicate have strong luminescence in the green region peaked at 510 nm.

One approach to increase the probability of the successful creation of the nano-crystallites during Stage 2 of the synthesis process is to increase duration of the t6 time interval. But, too long of a heat treatment may cause a crystallization of micro crystallites when almost all matter of the mixture is converted into the aggregation of crystallites with sizes exceeding 1000 nm. As a result, instead of transparent glass, non-transparent glass ceramics are produced.

A second example of producing the gamma-ray detection material 9 is now presented using the temperature program illustrated in FIG. 4. In this example, a composition 1:2 of chemicals BaO and SiO2 in mol. % and additive of 6 weight % of CeO₂ as an excess to BaO—SiO2 mixture is mixed and heated during time t1=10-60 min in the atmosphere to temperature Tg=480-520° C. and kept at this temperature for t2=1-20 min. The resulting glass is then heated during t3=10-60 min to Tp (e.g., 1380-1450° C.), kept there for t4=60-1200 min, and then quenched in the mold with the temperature decrease rate 20-100° C./min during time t5=15-70 min. This process results in nano-crystallites of barium disilicate, BaSi2O5, containing Ce³⁺ ions being distributed throughout the glass matrix 30. The Ce3+ ions in the barium disilicate nano-crystallites possess strong luminescence in the blue green region peaked at 480 nm. It can be appreciated that the outputs resulting from using the temperature programs depicted in FIGS. 3 and 4 are generally the same with respect to the nano-crystallites crystallizing in the glass matrix material. In the temperature program of FIG. 4, conditions for creating the nano-crystallites are obtained by slowing the cooling process in time period t5. If the cooling during this program is too slow, then the glass will be crystallized into micro-structured glass ceramics, which have dimensions greater than 1000 μm. Hence, precise temperature control is required so that cooling is fast enough to prevent crystallization into micro-structured crystallites, but yet slow enough to allow creation of the nano-crystallites.

The gamma-ray detection material produced using the temperature program in FIG. 4 may be fabricated into different shapes such as fibers or strips for use in applications other than those relating to borehole logging. The shapes may be produced by extruding the glass matrix material through a die during the cool down period t5 when the glass is still pliable. The die has an opening selected to produce the desired shape as the glass material is forced through it.

Since heavy glass matrix materials may exhibit strong optical absorption in the ultraviolet (UV) region and blue region of visible light, emission wavelengths due to scintillation are generally located in the green or yellow regions of light wavelengths.

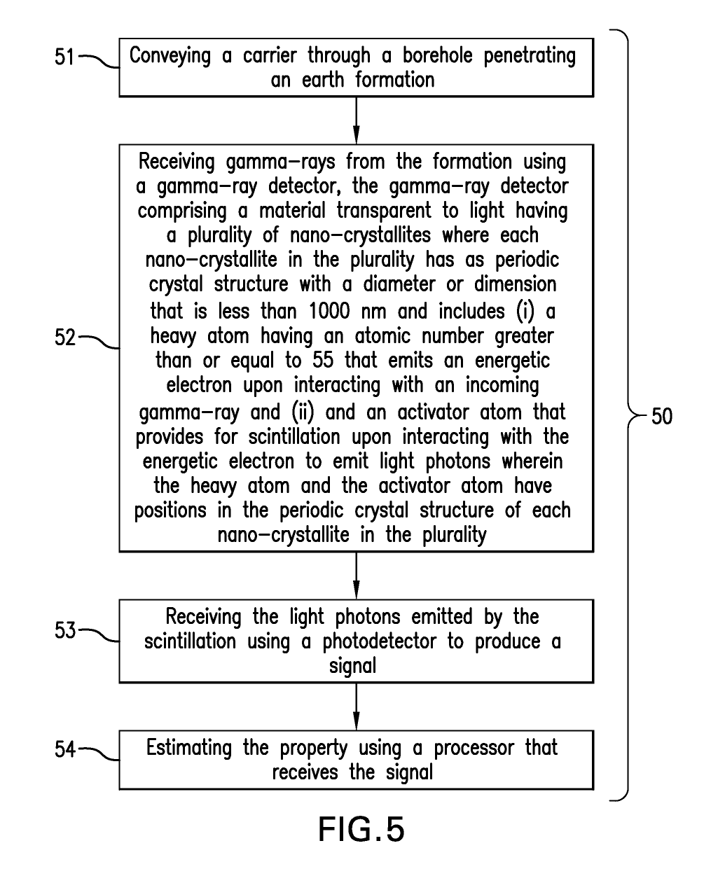

FIG. 5 is a flow chart of a method for estimating a property of an earth formation penetrated by a borehole. Block 51 calls for conveying a carrier through the borehole. Block 52 calls for receiving gamma-rays from the formation using a gamma-ray detector. The gamma-ray detector includes a material transparent to light having a plurality of nano-crystallites where each nano-crystallite in the plurality has as periodic crystal structure with a diameter or dimension (i.e., outside dimension) that is less than 1000 nm and includes (i) a heavy atom having an atomic number greater than or equal to 55 that emits an energetic electron upon interacting with an incoming gamma-ray and (ii) and an activator atom that provides for scintillation upon interacting with the energetic electron to emit light photons wherein the heavy atom and the activator atom have positions in the periodic crystal structure of each nano-crystallite in the plurality. Block 53 calls for receiving the light photons emitted by the scintillation using a photodetector to produce a signal. Block 54 calls for estimating the property using a processor that receives the signal.

The gamma-ray detector having the gamma-ray detection material disclosed herein provides many advantages over prior art gamma-ray detectors in use in the oil and gas industries and overcomes the disadvantages of the prior art detectors described below. Currently, the oil and gas downhole logging industry uses several different detector types to detect gamma rays. Traditionally, such detectors contain just a few types of inorganic gamma sensitive scintillation crystals such as NaI(Tl), CsI(Na), CsI(Tl) and BGO. But with time, less and less conveniently placed oil and gas reservoirs are left and it becomes more and more difficult to access hydrocarbon deposits. More sophisticated drilling and evaluation methods are required than needed in the past. Very often much higher temperature (175° C. or even more) must be managed during downhole measurements.

All these prior art scintillation crystals have disadvantages for high temperature applications. Single scintillation crystals such as NaI(Tl), CsI(Na), CsI(Tl) are hygroscopic and have low hardness. They need careful vibration and hygroscopic protection. Moreover, in the range 170-190° C. alkali halide materials demonstrate a peak of the allocation of water from the material. It deteriorates surfaces of the crystal and complicates detector calibration. BGO is hard and mechanically durable crystal, but its scintillation yield has a dramatic fall with temperature increase. BGO based scintillation detector requires careful and bulky thermo-insulation. An alternative to inorganic scintillator based detectors for high temperature applications use Geiger-Muller tubes for gamma ray detection. However, they have low efficiency of detection of γ-rays (about 1.5%).

In order to overcome such challenges, several new scintillators were tested for application in the industry in recent years, namely gadolinium silicate (GSO), gadolinium-yttrium silicate (GYSO) and most recently LaBr₃:Ce. Among them, the former material has better temperature dependence of the response. But lanthanum bromide possesses a set of drawbacks such as having internal radioactivity of scintillator material and being strongly hygroscopic.

In some downhole logging tools, for instance used in Logging While Drilling (LWD), an average lifetime of scintillation detector module is about one year or even less because of damage to hygroscopic scintillation crystal due to destruction of the housing under the high vibration conditions downhole. In addition, each single crystalline scintillator of non-cubic symmetry has non-isotropic thermal expansion and, as a result, only cylindrical single crystal scintillation elements can survive thermal cycling and vibration in downhole conditions. Also, it is often of great benefit to fill all the space available in a detector with scintillation material in order to maximize the amount of material available for detection. However, the cylindrical shape requirement may not be the ideal shape for making use of the all the available space. Composite materials having transparent glass embedded with nanoparticles of only scintillator material still remain an amorphous substance and, thus, will expand isotropically with the temperature increase.

The glass matrix detection material having nano-crystallites as disclosed herein can be produced in various shapes in order to make maximum use of the space available for this material in a detector in a downhole tool, thus increasing the probability of detecting an incoming gamma-ray. Further, having heavy atoms and activator atoms in the glass matrix surrounding the nano-crystallites also increases the probability of detecting an incoming gamma-ray.

It can be appreciated that the gamma-ray composite detection material disclosed herein may include glass ceramics and doping ions and may be used in devices and methods incorporating this material. Besides well logging applications, this material may be used in gamma-ray detectors in the medical imaging field, X-ray imaging field, and other fields requiring the detection or measurement of gamma-rays.

Fast Scintillating High Density Oxide and Oxy-Fluoride Glass and Nano-Structured Glass Ceramic Materials.

Other embodiments of scintillation materials for downhole applications are now discussed. These other embodiments provide high density and high light yield scintillation materials on a base material of glass (may also be referred to as glass matrix) or nanostructured glass ceramic.

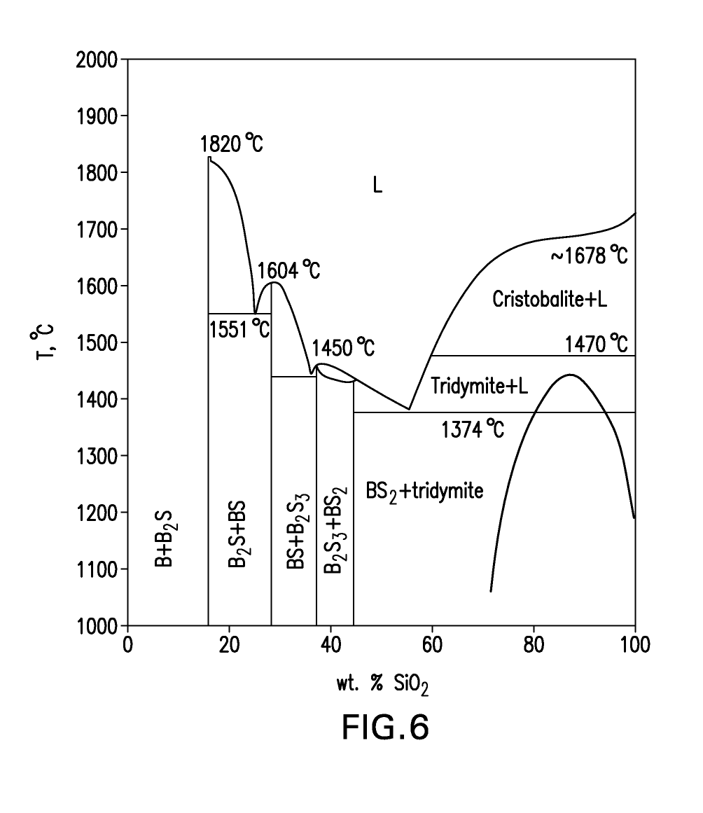

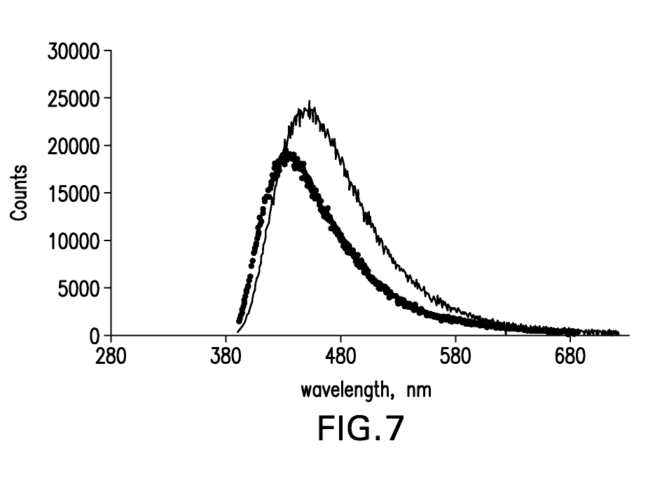

These other embodiments are reached by changing the composition of the glass with minimal amount of the light (i.e., light weight) ions. Referring to FIG. 6, which illustrates a diagram of states of the BaO—SiO2 system, it can be seen that the melting temperature of the composition is progressively increased with increase of BaO content in the melt and reaches 1604° C. at the BaO—SiO2 molar ratio 1:1. Thus, an increase of the BaO content in the resulting glass requires larger energy consumption and, as a result, becomes less cost-effective because glass of composition with BaO—SiO2 molar ratio 1:1 is hardly or not at all produced in a conventional natural gas oven and requires a specially designed oven with resistive heating and expensive platinum crucible. As can be seen from FIG. 6, there are several compositions creating stoichiometric compounds, namely: BaO—SiO2 with molar ratio (1:1, 2:3, 1:2). A composition of BaO and SiO₂ with molar ratio 1:2 with addition of CeO₂ as an excess to composition allows production glass or glass ceramics. “An excess to composition” means that Ce oxide is added to premix of stoichiometric mixture of BaO and SiO2. A composition of BaO and SiO₂ with molar ratio 2:3 with addition of CeO₂ as an excess to composition has a melting temperature close to the melting temperature of the composition BaO and SiO₂ with molar ratio 1:2. Density of the glass obtained from composition 2:3 is larger than 3.9 g/cm3 whereas density of the glass obtained from composition 1:2 does not exceed 3.7 g/cm3. Luminescence of the glass obtained from composition with molar ratio BaO and SiO₂ 2:3 and addition of CeO₂ as an excess to BaO—SiO₂ compositions has two bands with maximum near 432 and 448 nm as illustrated in FIG. 7. The band with maximum near 432 nm dominates at excitation 330 nm whereas 448 nm band dominates at the excitation 350-370 nm. FIG. 7 illustrates room temperature luminescence (solid line) at excitation 370 nm and excitation 330 nm (dotted line) of the glass worked from composition of BaO and SiO₂ with molar ration 2:3 with addition of CeO₂ as an excess to composition.

Partial substitution of Ba²⁺ ions by Li⁺ ions decreases density and effective charge Z_{eff} but increases light yield. Contrary to that, partial substitution of Si⁴⁺ by Al³⁺ does not change significantly density and effective charge of the resulting glass but also increases light yield.

However, light yield of the glass matrix obtained from the composition BaO and SiO₂ with molar ratio 2:3 is smaller that of the glass obtained from the composition BaO and SiO₂ with molar ratio 1:2. Scintillation glass become more effective for scintillation creation if ions, effectively transporting electronic excitations and promoting radiative recombination of Ce3+ ions, are embedded in the glass matrix.

Gadolinium Gd3+ ions magnify the range of the electronic excitation transport. Gd3+ ions, when their concentration is large enough in a wide-band inorganic compound, create a narrow electronic states subzone. It is formed by ⁶P states of 4f electronic configuration and has energy 4 eV above ground state. A radiating time constant of transition from ⁶P electronic energy levels to ground state is in a millisecond range. When concentration of Gd3+ ions is large enough, and distance between ions does not exceed a few unit cells, migration quenching occurs. This type of quenching reduces decay constant of the luminescence from 6P states to several microseconds for instance in Gd2SiO5 undoped crystal to 5 microseconds, but it is still high enough to allow transport of electronic excitations over relatively large distances.

The existence of a sub-zone simplifies the mechanism of occurrence of scintillation in the gadolinium-containing inorganic materials. An ensemble of excited Ce3+ ions occurs due to sensitization of the Ce3+ luminescence by Gd3+ ions.

Kinetics of scintillation n₃ (t) is described by a relatively simple expression, accounting a dipole-dipole interaction of Gd3+ donor (D) ions and Ce3+ acceptor (A) ions:

$${n}_{3} = ( {n}_{10}^{1} {W}_{da} / ( {W}_{da} + 1 / {τ}_{d} - 1 / {τ}_{a} ) ) ( exp ( ( - 1 / {τ}_{a} ) t ) - exp ( - ( {W}_{da} + 1 / {τ}_{d} ) t ) ) ++ {n}_{10}^{2} exp ( ( - 1 / {τ}_{a} ) t ) \times \times {\int }_{0}^{t} ( γ / 2 {t}^{- 1 / 2} + {W}_{dd} ) exp ( - γ {t}^{- 1 / 2} + ( 1 / {τ}_{a} - {W}_{dd} - 1 / {τ}_{d} - {W}_{aa} ) ) d t , \qquad ( 1 )$$

where γ4/3π^{3/2}n₃ n₃\sqrt{C_{DA}}, W_{dd}=0.684πα^{4/3} n₃n₁²C_{dd}^{3/4}C_{DA}^{1/4}, and τ_{D}-radiating time of ion Gd3+, τ_{A}—radiating time of ion Ce³⁺, W_{dd}—probability of donor-donor interaction, Wₐₐ—probability of acceptor-acceptor interaction, C_{DA}—constant of donor-acceptor dipole interaction, and C_{dd}—constant of donor-donor dipole interaction. The excited donor ions n₁₀ with upper index 1 are distributed in the spherical volumes of radius r₀ around acceptor ions Ce3+ where transfer occurs without fail, whereas donor ions with an index 2 are located off the spherical volumes. Interaction constants donor-acceptor C_{DA} and donor-donor C_{DD} have orders of 10⁻³⁶ cm⁶/s and 10⁻³⁹ cm⁶/s correspondingly at r₀ close to 10 Å.

Formula (1) shows that both kinetics scintillations and light yield (the integral kinetics) as well depend on the Ce3+ and Gd3+ donor concentration: the higher their concentration, the greater the yield of scintillations. However, with increasing of the Ce3+ concentration the migration losses also occurs. It causes a decrease of the quantum yield of intracenter Ce3+ luminescence and, as consequence, diminishes light yield. Thus, there is a limit for increasing the light yield by increasing the Ce3+ concentration.

Lu3+ ions, when their concentration is large enough in a wide-band inorganic compound, promote radiative recombination of Ce3+ ions. “Large enough concentration” means that there is at least one Lu ion in the volume (10 Å)³ of the material. Lu3+ ions have 4f electronic shell filled with 14 electrons. The filled shell strongly contributes in the density of electronic states in the upper part of valence band of compounds containing anionic ligands like oxygen O ions. At ionization, a high concentration of holes occurs in the top part of valence band of the compound with high concentration of lutetium ions. This promotes scintillation mechanism according the following scheme:

e+h+Ce³⁺→Ce⁴⁺+e→(Ce³⁺)*→(Ce^{3±})+photon

where plurality of holes h and electrons e created by ionizing radiation are captured successively by Ce3+ and Ce4+ ions to create final excited state of cerium (Ce3+)*.

Another mechanism of scintillation involving Ce4+ ions is presented in accordance with the following scheme:

e+h+Ce⁴⁺→(Ce³⁺)*+h→(Ce³⁺)+photon+h→Ce⁴⁺,

which requires creation in the scintillation body of hole (h) capturing centers. Creation of the hole capturing centers is achieved by partial substitution of ions forming scintillator by other ions having smaller valent state by one unit. In Gd₃Al₂Ga₃O₁₂:Ce, Gd3+ ions are partially substituted by Ca2+ atoms.

Both Gd and Lu ions are heavy ions. Thus further increase of the glass density and effective atomic charge Z_{eff} is achieved by admixture of the ions in the starting composition of the glass. The admixture of stoichiometric composition of Gd2O3 and SiO2 to stoichiometric composition BaO and SiO2 to the starting composition of the glass provides glass with minimal concentration of the defects which appear due to violation of the charge balance. At this point, it should be noted that discussions related to the scintillation material being a glass are also applicable to the scintillation material being a glass ceramic.

Heavy glass with maximal content of Gd3+ is achieved when starting composition is created by admixture of the stoichiometric composition of Gd2O3 and SiO2 with molar ratio 1:1, where Gd is partially substituted by Ce from 0 to 20 atomic %, to the composition BaO and SiO2 having 2:3 molar ratio. Glasses obtained from these compositions have density more than 4.5 g/cm3.

The glass density and Z_{eff} may be increased even more by admixture of the stoichiometric composition of Lu2O3 and SiO2 with molar ratio 1:1 to the composition of BaO and SiO2 with molar ratio 2:3 where Lu is partially substituted by Ce from 0 to 20 atomic %. Glasses obtained from these compositions have density more than 4.7 g/cm3.

Non-limiting examples of scintillation materials are now discussed where the required amounts of components in the material are presented in molar percent (%). A first example (Example 1) of a composition is 2BaO.3SiO₂.Gd₂O₃.SiO₂.CeO₂ in which BaO is 27.94%, SiO₂ is 36.83%, SiC is 19.05%, Gd₂O₃ is 13.97%, and CeO₂ is 2.21%. A second example (Example 2) of a composition is 2BaO.3SiO₂.Lu₂O₃.SiO₂.CeO₂ in which BaO is 27.92%, SiO₂ is 36.06%, SiC is 19.76%, Lu₂O₃ is 13.96%, and CeO₂ is 2.3%.

To make the scintillation process effective involving of Ce4+ ions, part of the Ba2+ ions can be substituted with Li+ ions. Another way is to replace part of the Si4+ ions by Al3+ ions. A third example (Example 3) shows an initial composition where part of the Ba2+ ions is substituted with Li1+ ions. The composition of the third example is 2(0.5BaO-0.25Li₂O).3SiO₂.Gd₂O₃. SiO₂.CeO₂:(n(Ba)=n(Li)=2*0.5=2*0.25*2) where BaO is 15.30%, Li₂O is 7.67%, SiO₂ is 43.51%, SiC is 17.70%, Lu₂O₃ is 13.96%, and CeO₂ is 1.87%.

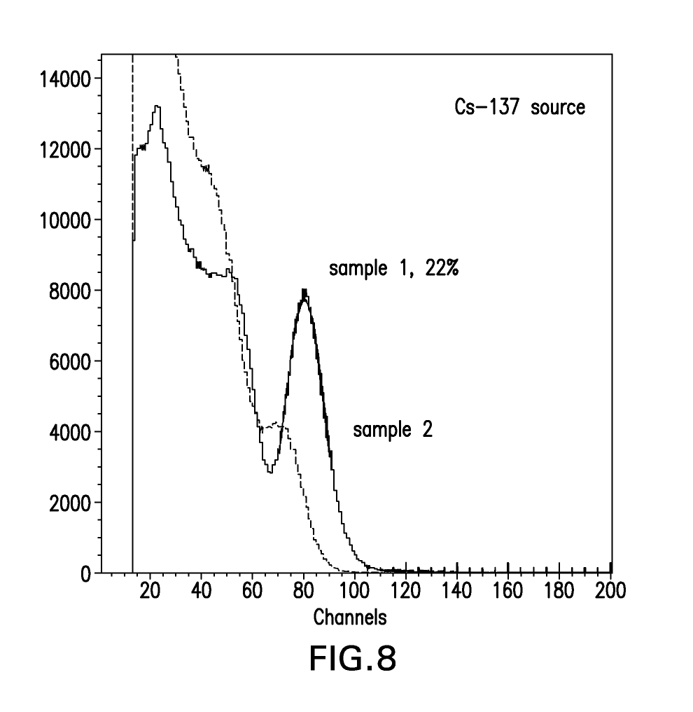

Introducing of lithium (Li) in the initial mixture makes the resulting glass lighter and decreases its effective Charge Zeff. FIG. 8 illustrates comparison of amplitude spectra of ¹³⁷Cs source (662 keV) measured with glass made from composition of Example 2 where part of Si⁴⁺ ions is substituted by Al³⁺ (sample 1 with dimensions 15×15×10 mm3) and from composition of Example 3 where ½ of Ba²⁺ ions is substituted by Li¹⁺ ions (sample 2 with dimensions 15×15×30 mm3) Source at measurements was placed on the 15×10 mm² and 15×30 mm² correspondingly. Energy resolution (FWHM—full width half maximum) at 662 keV with sample 1 was measured to be is 22%. It can be seen that photo-peak fraction is reasonably larger when scintillation glass made from composition of Example 2. In FIG. 8, the ordinate is Counts of detected photons and the abscissa is Channels related to energy of the detected photons.

When starting composition is created by a smaller quantity admixture of the stoichiometric composition of Gd2O3 and SiO2 with molar ratio 1:1, where Gd is partially substituted by Ce from 0 to 20 atomic %, to the composition BaO and SiO2 having 2:3 molar ratio, a drop in the light yield in the scintillator is observed. Light yield shows decrease by factor three when amount of stoichiometric composition of Gd2O3 and SiO2 with molar ratio 1:1 in the total composition is decreased two times.

The glass produced from oxide components contains some amount of ligands with unchained bonds. This makes amorphous glass loose and chaotic packed. So substitution of the 02-ligands reduces amount of unchained oxygen ions and makes glass denser. An increase of the resulting density and Z_{eff} and decrease of the temperature of the glass working are achieved by use of a composition of oxides and fluorides. Resulting glass is oxy-fluoride glass. Starting composition to prepare glass can be made by several ways: mechanical mixture of the chemicals and sol-gel approach. Sol-gel approach is a preferable procedure of the oxy-fluoride composition preparation because it is suitable to produce very homogeneous composition of the raw materials.

Compositions 2BaF₂.3SiO₂.2GdF₃.SiO₂.CeF₃ and 2BaF₂.3SiO₂.2LuF₃.SiO₂.CeF₃ are obtained by introduction of coprecipitated stoichiometric mixture of BaF₂, CeF₂ and GdF₃ in a gel of silica dioxide, which was produced by hydrolysis of the tetraethyl orthosilicate (Si(OC₂H₅)₄) in alkaline environment. Obtained compositions are dried and annealed before using for the glass as the scintillation material. Examples of chemical reactions using the sol-gel approach or method to obtain these compositions are:

$${Si ( {OC}_{2} {H}_{5} )}_{4} + 4 {H}_{2} O {}^{{OH}^{-}} {SiO}_{2} + 4 {C}_{2} {H}_{5} OH$$

$${xGD ( {NO}_{3} )}_{3} + {yBa ( {NO}_{3} )}_{2} + {zCe ( {NO}_{3} )}_{3} + ( 3 x + 2 y + 3 z ) {NH}_{4} F {xGDF}_{3} \cdot {yBaF}_{2} \cdot {zCeF}_{3} + ( 3 x + 2 y + 3 z ) {NH}_{4} {NO}_{3}$$

$$and$$

$${Si ( {OC}_{2} {H}_{5} )}_{4} + 4 {H}_{2} O {}^{{OH}^{-}} {SiO}_{2} + 4 {C}_{2} {H}_{5} OH$$

$${xLu ( {NO}_{3} )}_{3} + {yBa ( {NO}_{3} )}_{2} + {Ce ( {NO}_{3} )}_{3} + ( 3 x + 2 y + 3 z ) {NH}_{4} F {xLuF}_{3} \cdot {yBaF}_{2} \cdot {zCeF}_{3} + ( 3 x + 2 y + 3 z ) {NH}_{4} {NO}_{3} .$$

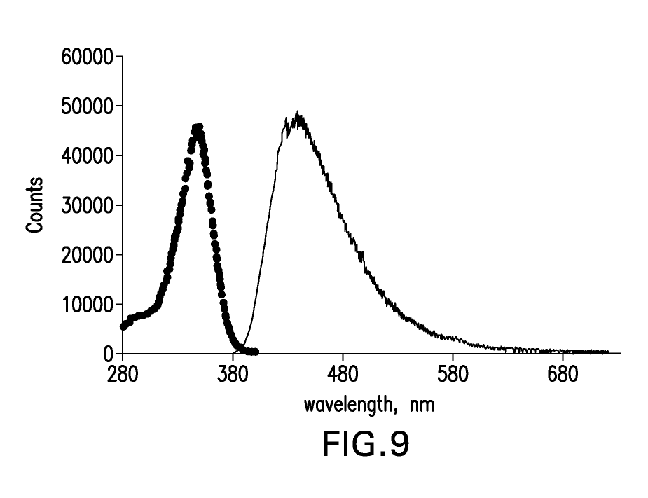

Examples of the above compositions in molar % (by individual components) produced by sol-gel method are now presented. In a fourth example (Example 4) the composition of glass or glass ceramic having 2BaF₂.3SiO₂.2GdF₃.SiO₂.CeF₃ is BaF₂ 24.94%, SiO₂ 49.88%, GdF₃ 24.93%, and CeF₃ 0.25%. In a fifth example (Example 5) the composition of glass or glass ceramic having 2BaF₂.3SiO₂.2LuF₃.SiO₂.CeF₃ is BaF₂ 24.94%, SiO₂ 49.87%, LuF₃ 24.94%, and CeF₃ 0.25%. Glasses and glass ceramics obtained from these compositions have density more than 5.4 g/cm³. FIG. 9 illustrates room temperature luminescence (right, solid) and luminescence excitation spectra at excitation of 350 nm (left, dots) of glass sample made from composition of Example 4. Luminescence band with maximum near 435 nm dominates in the spectrum.

There is a family of the materials that are called glass ceramics. These materials have an intermediate position between single crystals and glasses. Glass ceramics are the polycrystalline solids obtained due to controlled crystallization of the glass. In general, glass ceramics can be obtained by several methods. One of the methods is based on the synthesis of the microcrystallites inside the glass. In this case, the glass is made from a raw glass material with a chemical composition that is close to the chemical composition of the desired microcrystals. That means that microcrystallites have the same atoms which were in initial glass composition After melting, the glass is exposed to a temperature close to the crystallization temperature (i.e., in a temperature interval not less than minus 20% of the temperature of crystallization) for an extended period of time. The main goal of this step is to form the seeds of the desired microcrystals. After this, the glass is exposed to gradually increasing temperature (e.g., gradually increasing temperature can vary in the range 1-100° C./hour). The main goal of this step is to promote the growth of the microcrystals inside of the glass matrix. In general, microcrystallites at their formation in the glass can capture activating ions of Ce3+ and form scintillating species. It requires high concentration (e.g., up to 10 weight %) of Ce3+ in the precursor glass and crystallographic availability for cerium to be stabilized in the microcrystallite in the trivalent state where crystallographic availability means that there are ligand coordinations allowing stabilization of Ce3+ ions in the microcrystallites.

When crystallites reaches dimensions comparable with the ¼ wavelength of the light (100 nm) they make glass ceramic translucent or even not transparent. So dimensions of the crystallites should be carefully controlled and kept at the level of 100 nm or less such as by controlling the process of cooling and/or by controlling the process of gradually increasing temperature.

Nano-structured glass ceramics are the polycrystalline solids obtained due to controlled crystallization of the glass and with dimensions of the crystallites in the submicron range.

It can be appreciated that nano-structuring is created by nano-objects, the nano-objects having scintillation properties can also be impregnated or distributed throughout the gamma-quanta absorber scintillation glass matrix material. One skilled in the art will know that nano-objects are very small objects that are measured in nanometers. Nano objects can range in diameter from one nanometer to a hundred or more nanometers, but are generally less than one micron for purposes of this disclosure. It can be appreciated that while the gamma-quanta absorber material disclosed above is in the embodiment of a glass matrix, other embodiments of material transparent to light other than glass can also be used.

In general, nanostructured scintillation material for fast scintillating high density oxide and oxy-fluoride glass and nano-structured glass ceramic materials can be obtained by several methods. One of the methods is based on the synthesis used to obtain glass ceramics materials. After glass manufacturing, the glass is exposed to a temperature T which is higher than glass vitrification temperature Tg of the composition but less than T of the avalanche crystallization of Ba2SiO5 for an extended period of time (e.g., 0.1-100 hours). The main goal of this step is to form nano-objects in the glass matrix. These nano-objects provide nano-structuring of the glass. The glass itself and the glass ceramics are synthesized by heat treatment of the raw materials according to the temperature program illustrated in FIG. 3.

Referring to FIG. 3, Stage 1 of the synthesis process relates to melting the glass matrix material to form a homogeneous glass structure. It includes of several steps. During time period t1 (from 0.1 h to 24 h), the mixture is heated up to the temperature of vitrification Tg where different parts of the mixture start to smelt to each other and is kept at this temperature during time period t2 to outgas the material. The duration of t2 is different for different glasses and can vary from 0 to hundreds of hours. During time period t3, the temperature of the material is increased up to the glass preparing temperature Tp (0.1-100 h) at which viscosity of the melt is low. Tp varies in the range 1400-1550° C. depending on the equipment used. The obtained glass melt is kept at this temperature during time period t4 (0.1-100 h) for its homogenization and, after this it is cooled very rapidly at a cooling rate greater than 500° C./min to a temperature at or above room temperature.

The main goal of Stage 2 of the process illustrated in FIG. 3 is to create nano-structuring in the glass matrix by annealing for an extended period of time the glass obtained in Stage 1 at temperature Tc, which is higher than glass vitrification temperature Tg of the composition but less than T of the avalanche crystallization of Ba2SiO5. Time t5 is in the range 0.1-100 h and depends on the amount of the glass heated and construction of the oven as well. Then, the glass is annealed at constant temperature Tc during time period t6 which is vary from several minutes to several hours. Also, the temperature Tc can be slowly increased (e.g., with rate of 1-100° C./hr) during the crystallization depending on the composition of ingredients in the glass system.

One approach to increase the probability of successful nano-structuring creation during Stage 2 of the synthesis process is to increase duration of the t6. But, too long a heat treatment can cause a crystallization of micro-crystallites when almost all matter of the mixture is converted into the aggregation of crystallites with sizes exceeding 100 nm. As a result, instead of transparent glass, non-transparent glass ceramics is produced. It can be appreciated that the duration of t6 of the heat treatment process is dependent on the temperature being used such that lower temperatures may be applied for a longer duration than higher temperatures and yet avoid conversion into the aggregation of crystallites with sizes exceeding 100 μm.

Thermal treatment of the glass obtained from the composition BaO and SiO₂ with molar ratio 1:2 at the temperature 850° C. which is higher than glass vitrification temperature Tg but less than the temperature of the avalanche crystallization of Ba2SiO5 allows production of nano-particles in the glass. Thermal heat treatment of barium-silica glass, which was annealed at 850° C. for 15 minutes, shows the presence of nano-objects in the glass having dimensions less than 100 nm. Measurements of the contamination of the Ba, Si, O in the glass near nano-objects and inside of nano-objects indicate the similar content of cations in the surrounding glass and nano-objects. It indicates that nano-objects are nano-crystallites of the BaSi2O5 having dimensions less than 100 nm and they appear as a nano-scaled structural ordering of the glass in contrast to disordered glass having no structural ordering.

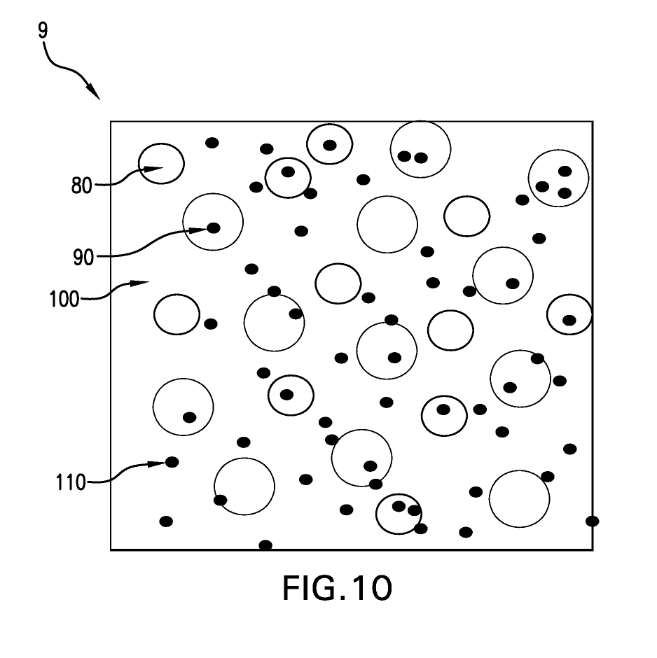

Glass was prepared from the mixture of Example 4 and annealed at temperature 850 C during 30 minutes. Treatment of the glass launches crystallization of plurality of the nano-crystallites in the body of glass. X-ray diffraction measurements identify several types of the crystallites in the material, namely: BaSi2O5, Gd2Si2O7, Gd2O3, Ba3Si5O13, and BaGd2Si3O10. Created nano-crystallites are oxide crystallites. All created nano-crystallites are not necessary scintillating nano-objects even if they capture Ce3+. For instance, Gd2O3 crystallites with Ce3+ ions do not scintillate. However, density of Gd2O3 is larger than 7 g/cm3, so creation nano-objects of Gd2O3 lead to the glass compacting and increasing density. FIG. 10 illustrates a schematic drawing of the nano-structured glass ceramics where nano-objects are represented as circles. In practice they can have different shapes which are caused by their chemical composition. Non-scintillating nano-objects 80 and scintillating nano-objects 90 are distributed in the glass 100. Ions of Ce activator 110 are distributed in the glass (or glass ceramics) and nano-objects (i.e., nano-crystallites). It should be noted that there is a difference between nano-crystallites synthesized within the glass and nano-crystallites synthesized outside of the glass and then distributed within molten glass. The majority of the nano-crystallites synthesized outside of the glass and then distributed in molten glass will be dissolved, so the concentration of those particular nano-crystallites in the resulting composite will be much smaller than the nano-crystallites synthesized in the glass.

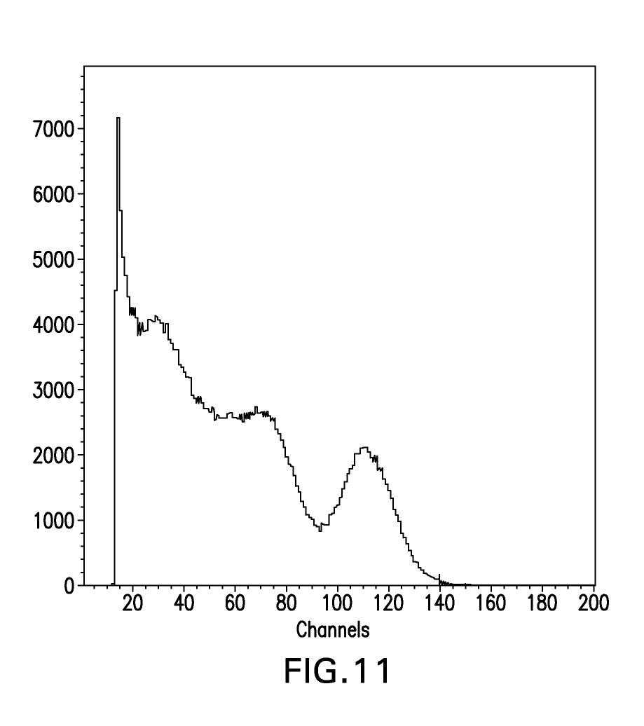

FIG. 11 illustrates amplitude spectrum of ¹³⁷Cs source (662 keV) measured with a sample of nano-structured glass ceramics obtained after annealing of the glass sample made of the composition described in Example 4. The glass ceramics sample has dimensions 9×5, 5×5 mm3 obtained after annealing at 850° C. Energy resolution at 662 keV FWHM is 21%. In FIG. 11, the ordinate is Counts of detected photons and the abscissa is Channels related to energy of the detected photons.

One approach to increase the probability of the successful nano-structuring creation during Stage 2 of the synthesis process is to increase Tc above the crystallization temperature of Ba2SiO5. But, increase of the heat treatment temperature can cause a crystallization of a plurality of non-scintillating nano-crystallites. One of the non-scintillating nano-crystallites is GdF3 crystallites having captured Ce ions. GdF3:Ce does not scintillate. Increase of the non-scintillating nano-objects fraction in the plurality of the nano-objects results in the total light yield decrease of the nano-structured glass ceramics. This is resolved by limiting of the heat treatment temperature to a level below 1000° C.

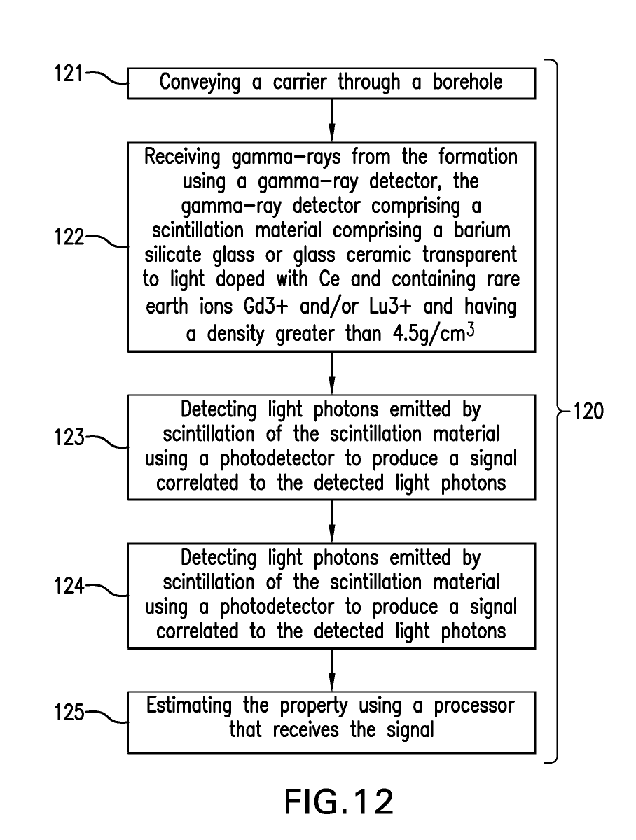

Referring now to FIG. 12, a flow chart for a method 120 for estimating a property of an earth formation penetrated by a borehole is presented. Block 121 calls for conveying a carrier through the borehole. Block 122 calls for receiving gamma-rays from the formation using a gamma-ray detector, the gamma-ray detector having a scintillation material that includes a barium silicate glass or glass ceramic transparent to light doped with Ce and containing rare earth ions Gd3+ and/or Lu3+ and having a density greater than 4.5 g/cm³, wherein the barium silicate glass or glass ceramic includes (i) scintillation nano-crystallites comprising the rare earth ions Gd3+ and/or Lu3+ and the Ce in structured crystal positions, (ii) non-scintillation nano-crystallites comprising the rare earth ions Gd3+ and/or Lu3+ and the Ce in structured crystal positions, and (iii) the Ce disposed in the barium silicate glass or glass ceramic in non-crystallite form. In one or more embodiments, Gd3+ and/or Lu3+ are the only types of rare earth ions used in the barium silicate glass or glass ceramic. Block 123 calls for detecting light photons emitted by scintillation of the scintillation material using a photodetector to produce a signal correlated to the detected light photons. Block 124 calls for estimating the property using a processor that receives the signal. The processor may count pulses of at least one of electric current and voltage using the processor to estimate the property. Further, the processor may compare the counted pulses to a reference to estimate the property.

In one or more embodiments, the scintillation material includes: at least one selection from a group consisting of BaO and BaF₂, up to molar 40%; at least one selection from a group consisting of SiO₂ with SiC and SiO₂ without SiC, up to mol. 67%; at least one selection from a group consisting of Gd₂O₃, Lu₂O₃, GdF₃, and LuF₃, up to mol. 58%; and at least one selection from a group consisting of CeO₂ and CeF3, up to 20% from an amount of BaO, BaF₂, Gd₂O₃, Lu₂O₃, GdF₃, and/or LuF₃ present in the scintillation material.

In one or more embodiments, the scintillation material includes: at least one selection from a group consisting of BaO and BaF₂, up to molar 40%; at least one selection from a group consisting of SiO₂ with SiC and SiO₂ without SiC, up to mol. 67%; at least one selection from a group consisting of Gd₂O₃, Lu₂O₃, GdF₃, and LuF₃, up to mol. 58%; at least one selection from a group consisting of Al₂O₃ and AlF₃, up to 20%; and at least one selection from a group consisting of CeO₂ and CeF3, up to 20% from an amount of BaO, BaF₂, Gd₂O₃, Lu₂O₃, GdF₃, and/or LuF₃ present in the scintillation material.

In one or more embodiments, the scintillation material includes: at least one selection from a group consisting of BaO and BaF₂, up to molar 40%; at least one selection from a group consisting of SiO₂ with SiC and SiO₂ without SiC, up to mol. 67%; at least one selection from a group consisting of Gd₂O₃, Lu₂O₃, GdF₃, and LuF₃, up to mol. 58%; at least one selection from a group consisting of Li₂O and LiF, up to 20%; and at least one selection from a group consisting of CeO₂ and CeF3, up to 20% from an amount of BaO, BaF₂, Gd₂O₃, Lu₂O₃, GdF₃, and/or LuF₃ present in the scintillation material.

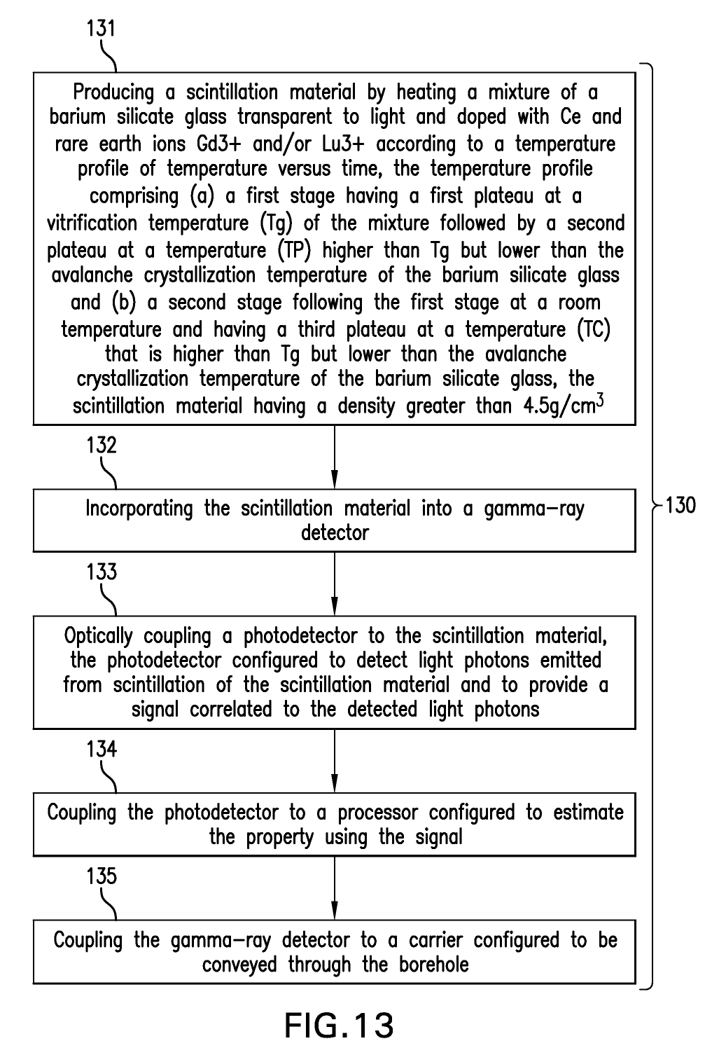

Referring now to FIG. 13, a flow chart for a method 130 for producing an apparatus for estimating a property of an earth formation penetrated by a borehole is presented. Block 131 calls for producing a scintillation material by heating a mixture of a barium silicate glass transparent to light and doped with Ce and rare earth ions Gd3+ and/or Lu3+ according to a temperature profile of temperature versus time, the temperature profile comprising (a) a first stage having a first plateau at a vitrification temperature (T_{g}) of the mixture followed by a second plateau at a temperature (T₁) higher than T_{g} but lower than the avalanche crystallization temperature of the barium silicate glass and (b) a second stage following the first stage at a temperature lower than T₁ and having a third plateau at a temperature (T₂) that is higher than T_{g} but lower than the avalanche crystallization temperature of the barium silicate glass to produce a barium silicate glass and/or glass ceramic, the scintillation material having a density greater than 4.5 g/cm³, wherein the barium silicate glass or glass ceramic comprises (i) scintillation nano-crystallites comprising the rare earth ions Gd3+ and/or Lu3+ and the Ce in structured crystal positions, (ii) non-scintillation nano-crystallites comprising the rare earth ions Gd3+ and/or Lu3+ and the Ce in structured crystal positions, and (iii) the Ce disposed in the barium silicate glass or glass ceramic in non-crystallite form. The mixture may be heated using an oven (not shown) configured to heat the mixture according to a selected temperature profile. The oven may include components such as a temperature sensor, heating element and programmable controller for heating the mixture in accordance with the selected temperature profile. Block 132 calls for incorporating the scintillation material into a gamma-ray detector. Block 133 calls for optically coupling a photodetector to the scintillation material, the photodetector configured to detect light photons emitted from scintillation of the scintillation material and to provide a signal correlated to the detected light photons. Block 134 calls for coupling the photodetector to a processor configured to estimate the property using the signal. Block 135 calls for coupling the gamma-ray detector to a carrier configured to be conveyed through the borehole.

In one or more embodiments, the mixture includes: at least one selection from a group consisting of BaO and BaF₂, up to molar 40%; at least one selection from a group consisting of SiO₂ with SiC and SiO₂ without SiC, up to mol. 67%; at least one selection from a group consisting of Gd₂O₃, Lu₂O₃, GdF₃, and LuF₃, up to mol. 58%; and at least one selection from a group consisting of CeO₂ and CeF3, up to 20% from an amount of BaO, BaF₂, Gd₂O₃, Lu₂O₃, GdF₃, and/or LuF₃ present in the scintillation material.

In one or more embodiments, the mixture includes: at least one selection from a group consisting of BaO and BaF₂, up to molar 40%; at least one selection from a group consisting of SiO₂ with SiC and SiO₂ without SiC, up to mol. 67%; at least one selection from a group consisting of Gd₂O₃, Lu₂O₃, GdF₃, and LuF₃, up to mol. 58%; at least one selection from a group consisting of Al₂O₃ and AlF₃, up to 20%; and at least one selection from a group consisting of CeO₂ and CeF3, up to 20% from an amount of BaO, BaF₂, Gd₂O₃, Lu₂O₃, GdF₃, and/or LuF₃ present in the scintillation material.

In one or more embodiments, the mixture includes: at least one selection from a group consisting of BaO and BaF₂, up to molar 40%; at least one selection from a group consisting of SiO₂ with SiC and SiO₂ without SiC, up to mol. 67%; at least one selection from a group consisting of Gd₂O₃, Lu₂O₃, GdF₃, and LuF₃, up to mol. 58%; at least one selection from a group consisting of Li₂O and LiF, up to 20%; and at least one selection from a group consisting of CeO₂ and CeF3, up to 20% from an amount of BaO, BaF₂, Gd₂O₃, Lu₂O₃, GdF₃, and/or LuF₃ present in the scintillation material.

The scintillation material disclosed herein, having high density and high light yield scintillation materials on a base material of glass or nanostructured glass ceramic, has several advantages over prior art or conventional scintillation material. Among a variety of scintillation materials, inorganic materials, especially crystalline materials, can combine unique set of parameters: high stopping power to ionizing radiation, high light yield and fastness of scintillation. From them, lead tungstate PbWO₄ crystal with density 8.28 g/cm3 has the highest stopping power to ionizing gamma-quanta and charged particles, and fast scintillation kinetics with decay constant less than 12 ns at room temperature. However, PbWO₄ has a small light yield allowing application of the material predominantly in high energy physics experiments. Lutetium orthosilicate doped with Ce ions has smaller but still high density 7.4 g/cm3, fast scintillation with decay constant 40 ns and high light yield of up to 30000 photons/MeV. However, majority of crystalline materials are produced by the method of pulling from the melt. Lutetium silicate doped with Ce pulled from the melt at temperature above 1900° C. At crystal pulling by Czochralski or Bridgeman methods, commonly used to produce quality crystals or their modifications, the pulling rate of the crystal ingot from the melt does not exceed several millimeters per hour. So general drawback of these methods is a small rate of the transformation of the melted raw material in the product.

An alternative to the crystalline material is glass. Glass is an inorganic product of fusion which has cooled to a rigid condition without crystallizing. Glass materials can be worked in the mold, moreover, vast amount of the material can be obtained in a relatively short period of time. However, most of the glasses do not possess scintillation properties. Among scintillation glasses, lithium silicate glasses doped with Ce ions show high light yield (LY), however their density is bellow 3 g/cm3. It makes stopping power of these glasses too small to γ-quanta and charged particles, and limits their application in detectors. Barium (Ba) containing glasses have higher density, however they have smallest LY in the series of silicate glasses. Another class of prior art glasses is colorless cerium and phosphorus-containing barium silicate glasses with a density 3.3-4.13 g/cm3 and a radiation length less than 43.5 mm, with strong fluorescence at 415-430 nm. Maximal density of these glass is achieved with a composition containing 10 different elements where content of BaO was 55.6 weight %. Nevertheless, further increase of the glass density by increasing of the BaO content in initial mixture lead to increase of the temperature of the glass working as illustrated in FIG. 6 illustrating the diagram of states in the BaO—SiO2 system.

It can be seen in FIG. 6 that the melting temperature of the composition is progressively increased with increase of BaO content in the melt and reaches 1604° C. at the BaO—SiO2 molar ratio 1:1. Thus, an increase of the BaO content in the resulting glass requires larger energy consumption and, as a result, becomes less cost-effective. Transparent glass and glass composite scintillators having nanoparticles distributed in the glass body are described in These transparent glass composites, having a nano phosphor embedded in a glass composite and produced in a silica-alumina glass system are considered to be effective for scintillation applications because the probability of radiative recombination in ordered crystalline environments is usually larger than in disordered amorphous glass matrices. In an alternate embodiment, prior art transparent glass composites having a nano phosphor embedded in a glass composite has a halide, namely F, Cl, or Br, which can have several roles in the transparent glass composite and its preparation. Particularly, high Z halides can have higher interactions with the incoming nuclear radiation. An initial composition of was used to fabricate the transparent glass composite. The initial composition included a matrix metal compound and a dopant metal compound. The matrix metal compound was selected to be a high Z metal compound where metals are gadolinium, strontium, barium, lutetium, lanthanum, yttrium, or calcium. It was determined that Ce3+ ions act as a luminescence center when paired with GdBr3 in the glass composite. A conjoint incorporation of CeBr3 and GdBr3 in the initial composition was found to be required to obtain scintillation glass composite materials with a reasonable light yield. However, energy resolution (full width at half maximum) of the composite material was found to be poor and does not exceed 26% for 662 keV gamma-quanta.

Set forth below are some embodiments of the foregoing disclosure:

### Embodiment 1

An apparatus for estimating a property of an earth formation penetrated by a borehole, the apparatus comprising: a carrier configured to be conveyed through the borehole; a gamma-ray detector disposed on the carrier and comprising a scintillation material, the scintillation material comprising a barium silicate glass or glass ceramic transparent to light doped with Ce and containing ions of elements with atomic numbers greater than or equal to 55, and having a density greater than 4.5 g/cm³; a photodetector optically coupled to the scintillation material and configured to detect light photons emitted from the scintillation and to provide a signal correlated to the detected light photons; and a processor configured to estimate the property using the signal.

### Embodiment 2

The apparatus according to claim 1, wherein the ions of elements with atomic numbers greater than or equal to 55 comprise rare earth ions Gd3+ and/or Lu3+ and the barium silicate glass or glass ceramic comprises (i) scintillation nano-crystallites comprising the rare earth ions Gd3+ and/or Lu3+ and the Ce in structured crystal positions, (ii) non-scintillation nano-crystallites comprising the rare earth ions Gd3+ and/or Lu3+ and the Ce in structured crystal positions, and (iii) the Ce disposed in the barium silicate glass or glass ceramic in non-crystallite form.

### Embodiment 3

The apparatus according to claim 2, wherein scintillation material comprises: at least one selection from a group consisting of BaO and BaF₂, up to molar 40%; at least one selection from a group consisting of SiO₂ with SiC and SiO₂ without SiC, up to mol. 67%; at least one selection from a group consisting of Gd₂O₃, Lu₂O₃, GdF₃, and LuF₃, up to mol. 58%; and at least one selection from a group consisting of CeO₂ and CeF3, up to 20% from an amount of BaO, BaF₂, Gd₂O₃, Lu₂O₃, GdF₃, and/or LuF₃ present in the scintillation material.

### Embodiment 4

The apparatus according to claim 2, wherein the scintillation material comprises: at least one selection from a group consisting of BaO and BaF₂, up to molar 40%; at least one selection from a group consisting of SiO₂ with SiC and SiO₂ without SiC, up to mol. 67%; at least one selection from a group consisting of Gd₂O₃, Lu₂O₃, GdF₃, and LuF₃, up to mol. 58%; at least one selection from a group consisting of Al₂O₃ and AlF₃, up to 20%; and at least one selection from a group consisting of CeO₂ and CeF3, up to 20% from an amount of BaO, BaF₂, Gd₂O₃, Lu₂O₃, GdF₃, and/or LuF₃ present in the scintillation material.

### Embodiment 5

The apparatus according to claim 2, wherein the scintillation material comprises: at least one selection from a group consisting of BaO and BaF₂, up to molar 40%; at least one selection from a group consisting of SiO₂ with SiC and SiO₂ without SiC, up to mol. 67%; at least one selection from a group consisting of Gd₂O₃, Lu₂O₃, GdF₃, and LuF₃, up to mol. 58%; at least one selection from a group consisting of Li₂O and LiF, up to 20%; and at least one selection from a group consisting of CeO₂ and CeF3, up to 20% from an amount of BaO, BaF₂, Gd₂O₃, Lu₂O₃, GdF₃, and/or LuF₃ present in the scintillation material.

### Embodiment 6

The apparatus according to claim 1, wherein the processor is further configured to count pulses of at least one of electric current and voltage to estimate the property.

### Embodiment 7

The apparatus according to claim 6, wherein the processor is further configured to compare the counted pulses of at least one of electric current and voltage to a reference to estimate the property.

### Embodiment 8

The apparatus according to claim 1, wherein the carrier comprises a wireline, a drill string or coiled tubing.

### Embodiment 9

A method for estimating a property of an earth formation penetrated by a borehole, the method comprising: conveying a carrier through the borehole; receiving gamma-rays from the formation using a gamma-ray detector, the gamma-ray detector comprising a scintillation material comprising a barium silicate glass or glass ceramic transparent to light doped with Ce and containing ions of elements with atomic numbers greater than or equal to 55, and having a density greater than 4.5 g/cm³; detecting light photons emitted by scintillation of the scintillation material using a photodetector to produce a signal correlated to the detected light photons; and estimating the property using a processor that receives the signal.

### Embodiment 10

The method according to claim 9, wherein the ions of elements with atomic numbers greater than or equal to 55 comprise rare earth ions Gd3+ and/or Lu3+ and the barium silicate glass or glass ceramic comprises (i) scintillation nano-crystallites comprising the rare earth ions Gd3+ and/or Lu3+ and the Ce in structured crystal positions, (ii) non-scintillation nano-crystallites comprising the rare earth ions Gd3+ and/or Lu3+ and the Ce in structured crystal positions, and (iii) the Ce disposed in the barium silicate glass or glass ceramic in non-crystallite form.

### Embodiment 11

The method according to claim 10, wherein the scintillation material comprises: at least one selection from a group consisting of BaO and BaF₂, up to molar 40%; at least one selection from a group consisting of SiO₂ with SiC and SiO₂ without SiC, up to mol. 67%; at least one selection from a group consisting of Gd₂O₃, Lu₂O₃, GdF₃, and LuF₃, up to mol. 58%; and at least one selection from a group consisting of CeO₂ and CeF3, up to 20% from an amount of BaO, BaF₂, Gd₂O₃, Lu₂O₃, GdF₃, and/or LuF₃ present in the scintillation material.

### Embodiment 12

The method according to claim 10, wherein the scintillation material comprises: at least one selection from a group consisting of BaO and BaF₂, up to molar 40%; at least one selection from a group consisting of SiO₂ with SiC and SiO₂ without SiC, up to mol. 67%; at least one selection from a group consisting of Gd₂O₃, Lu₂O₃, GdF₃, and LuF₃, up to mol. 58%; at least one selection from a group consisting of Al₂O₃ and AlF₃, up to 20%; and at least one selection from a group consisting of CeO₂ and CeF3, up to 20% from an amount of BaO, BaF₂, Gd₂O₃, Lu₂O₃, GdF₃, and/or LuF₃ present in the scintillation material.

### Embodiment 13

The method according to claim 10, wherein the scintillation material comprises: at least one selection from a group consisting of BaO and BaF₂, up to molar 40%; at least one selection from a group consisting of SiO₂ with SiC and SiO₂ without SiC, up to mol. 67%; at least one selection from a group consisting of Gd₂O₃, Lu₂O₃, GdF₃, and LuF₃, up to mol. 58%; at least one selection from a group consisting of Li₂O and LiF, up to 20%; and at least one selection from a group consisting of CeO₂ and CeF3, up to 20% from an amount of BaO, BaF₂, Gd₂O₃, Lu₂O₃, GdF₃, and/or LuF₃ present in the scintillation material.

### Embodiment 14

The method according to claim 10, further comprising counting pulses of at least one of electric current and voltage using the processor to estimate the property.

### Embodiment 15

The method according to claim 14, further comprising comparing the counted pulses to a reference to estimate the property.

### Embodiment 16

A method for producing an apparatus for estimating a property of an earth formation penetrated by a borehole, the method comprising: producing a scintillation material by heating a mixture of a barium silicate glass transparent to light and doped with Ce and rare earth ions of elements with atomic numbers greater than or equal to 55 according to a temperature profile of temperature versus time, the temperature profile comprising (a) a first stage having a first plateau at a vitrification temperature (T_{g}) of the mixture followed by a second plateau at a temperature (T_{P}) higher than T_{g} but lower than the avalanche crystallization temperature of the barium silicate glass and (b) a second stage following the first stage at a room temperature and having a third plateau at a temperature (T_{C}) that is higher than T_{g} but lower than the avalanche crystallization temperature of the barium silicate glass to produce a barium silicate glass and/or glass ceramic, the scintillation material having a density greater than 4.5 g/cm³; incorporating the scintillation material into a gamma-ray detector; optically coupling a photodetector to the scintillation material, the photodetector configured to detect light photons emitted from scintillation of the scintillation material and to provide a signal correlated to the detected light photons; coupling the photodetector to a processor configured to estimate the property using the signal; and coupling the gamma-ray detector to a carrier configured to be conveyed through the borehole.

### Embodiment 17

The method according to claim 16, wherein the ions of elements with atomic numbers greater than or equal to 55 comprise rare earth ions Gd3+ and/or Lu3+ and the barium silicate glass or glass ceramic comprises (i) scintillation nano-crystallites comprising the rare earth ions Gd3+ and/or Lu3+ and the Ce in structured crystal positions, (ii) non-scintillation nano-crystallites comprising the rare earth ions Gd3+ and/or Lu3+ and the Ce in structured crystal positions, and (iii) the Ce disposed in the barium silicate glass or glass ceramic in non-crystallite form.

### Embodiment 18

The method according to claim 17, wherein the mixture comprises: at least one selection from a group consisting of BaO and BaF₂, up to molar 40%; at least one selection from a group consisting of SiO₂ with SiC and SiO₂ without SiC, up to mol. 67%; at least one selection from a group consisting of Gd₂O₃, Lu₂O₃, GdF₃, and LuF₃, up to mol. 58%; and at least one selection from a group consisting of CeO₂ and CeF3, up to 20% from an amount of BaO, BaF₂, Gd₂O₃, Lu₂O₃, GdF₃, and/or LuF₃ present in the scintillation material.

### Embodiment 19

The method according to claim 17, wherein the mixture comprises: at least one selection from a group consisting of BaO and BaF₂, up to molar 40%; at least one selection from a group consisting of SiO₂ with SiC and SiO₂ without SiC, up to mol. 67%; at least one selection from a group consisting of Gd₂O₃, Lu₂O₃, GdF₃, and LuF₃, up to mol. 58%; at least one selection from a group consisting of Al₂O₃ and AlF₃, up to 20%; and at least one selection from a group consisting of CeO₂ and CeF3, up to 20% from an amount of BaO, BaF₂, Gd₂O₃, Lu₂O₃, GdF₃, and/or LuF₃ present in the scintillation material.

### Embodiment 20

The method according to claim 17, wherein the mixture comprises: at least one selection from a group consisting of BaO and BaF₂, up to molar 40%; at least one selection from a group consisting of SiO₂ with SiC and SiO₂ without SiC, up to mol. 67%; at least one selection from a group consisting of Gd₂O₃, Lu₂O₃, GdF₃, and LuF₃, up to mol. 58%; at least one selection from a group consisting of Li₂O and LiF, up to 20%; and at least one selection from a group consisting of CeO₂ and CeF3, up to 20% from an amount of BaO, BaF₂, Gd₂O₃, Lu₂O₃, GdF₃, and/or LuF₃ present in the scintillation material.

In support of the teachings herein, various analysis components may be used, including a digital and/or an analog system. For example, the downhole electronics 12 or the surface computer processing 13 may include the digital and/or analog system. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a non-transitory computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

In support of the teachings herein, various analysis components may be used, including a digital and/or an analog system. For example, the downhole electronics 12 or the surface computer processing 13 may include the digital and/or analog system. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a non-transitory computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply (e.g., at least one of a generator, a remote supply and a battery), cooling component, heating component, magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

The term “carrier” as used herein means any device, device component, combination of devices, media and/or member that may be used to convey, house, support or otherwise facilitate the use of another device, device component, combination of devices, media and/or member. Other exemplary non-limiting carriers include drill strings of the coiled tube type, of the jointed pipe type and any combination or portion thereof. Other carrier examples include casing pipes, wirelines, wireline sondes, slickline sondes, drop shots, bottom-hole-assemblies, drill string inserts, modules, internal housings and substrate portions thereof.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms. The term “couple” relates to a first component being coupled to a second component either directly or via an intermediary component. The term “configured” relates to one or more structural limitations of a device that are required for the device to perform the function or operation for which the device is configured.

The flow diagram depicted herein is just an example. There may be many variations to this diagram or the steps (or operations) described therein without departing from the spirit of the invention. For instance, the steps may be performed in a differing order, or steps may be added, deleted or modified. All of these variations are considered a part of the claimed invention.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for estimating a property of an earth formation penetrated by a borehole, the apparatus comprising:
a carrier configured to be conveyed through the borehole;
a gamma-ray detector disposed on the carrier and comprising a scintillation material, the scintillation material comprising a barium silicate glass or glass ceramic transparent to light doped with Ce and containing ions of elements with atomic numbers greater than or equal to 55, and having a density greater than 4.5 g/cm³;
a photodetector optically coupled to the scintillation material and configured to detect light photons emitted from the scintillation and to provide a signal correlated to the detected light photons; and
a processor configured to estimate the property using the signal.

2. The apparatus according to claim 1, wherein the ions of elements with atomic numbers greater than or equal to 55 comprise rare earth ions Gd3+ and/or Lu3+ and the barium silicate glass or glass ceramic comprises (i) scintillation nano-crystallites comprising the rare earth ions Gd3+ and/or Lu3+ and the Ce in structured crystal positions, (ii) non-scintillation nano-crystallites comprising the rare earth ions Gd3+ and/or Lu3+ and the Ce in structured crystal positions, and (iii) the Ce disposed in the barium silicate glass or glass ceramic in non-crystallite form.

3. The apparatus according to claim 2, wherein scintillation material comprises: at least one selection from a group consisting of BaO and BaF₂, up to molar 40%; at least one selection from a group consisting of SiO₂ with SiC and SiO₂ without SiC, up to mol. 67%; at least one selection from a group consisting of Gd₂O₃, Lu₂O₃, GdF₃, and LuF₃, up to mol. 58%; and at least one selection from a group consisting of CeO₂ and CeF3, up to 20% from an amount of BaO, BaF₂, Gd₂O₃, Lu₂O₃, GdF₃, and/or LuF₃ present in the scintillation material.

4. The apparatus according to claim 2, wherein the scintillation material comprises: at least one selection from a group consisting of BaO and BaF₂, up to molar 40%; at least one selection from a group consisting of SiO₂ with SiC and SiO₂ without SiC, up to mol. 67%; at least one selection from a group consisting of Gd₂O₃, Lu₂O₃, GdF₃, and LuF₃, up to mol. 58%; at least one selection from a group consisting of Al₂O₃ and AlF₃, up to 20%; and at least one selection from a group consisting of CeO₂ and CeF3, up to 20% from an amount of BaO, BaF₂, Gd₂O₃, Lu₂O₃, GdF₃, and/or LuF₃ present in the scintillation material.

5. The apparatus according to claim 2, wherein the scintillation material comprises: at least one selection from a group consisting of BaO and BaF₂, up to molar 40%; at least one selection from a group consisting of SiO₂ with SiC and SiO₂ without SiC, up to mol. 67%; at least one selection from a group consisting of Gd₂O₃, Lu₂O₃, GdF₃, and LuF₃, up to mol. 58%; at least one selection from a group consisting of Li₂O and LiF, up to 20%; and at least one selection from a group consisting of CeO₂ and CeF3, up to 20% from an amount of BaO, BaF₂, Gd₂O₃, Lu₂O₃, GdF₃, and/or LuF₃ present in the scintillation material.

6. The apparatus according to claim 1, wherein the processor is further configured to count pulses of at least one of electric current and voltage to estimate the property.

7. The apparatus according to claim 6, wherein the processor is further configured to compare the counted pulses of at least one of electric current and voltage to a reference to estimate the property.

8. The apparatus according to claim 1, wherein the carrier comprises a wireline, a drill string or coiled tubing.

9. A method for estimating a property of an earth formation penetrated by a borehole, the method comprising:
conveying a carrier through the borehole;
receiving gamma-rays from the formation using a gamma-ray detector, the gamma-ray detector comprising a scintillation material comprising a barium silicate glass or glass ceramic transparent to light doped with Ce and containing ions of elements with atomic numbers greater than or equal to 55, and having a density greater than 4.5 g/cm³;
detecting light photons emitted by scintillation of the scintillation material using a photodetector to produce a signal correlated to the detected light photons; and
estimating the property using a processor that receives the signal.

10. The method according to claim 9, wherein the ions of elements with atomic numbers greater than or equal to 55 comprise rare earth ions Gd3+ and/or Lu3+ and the barium silicate glass or glass ceramic comprises (i) scintillation nano-crystallites comprising the rare earth ions Gd3+ and/or Lu3+ and the Ce in structured crystal positions, (ii) non-scintillation nano-crystallites comprising the rare earth ions Gd3+ and/or Lu3+ and the Ce in structured crystal positions, and (iii) the Ce disposed in the barium silicate glass or glass ceramic in non-crystallite form.

11. The method according to claim 10, wherein the scintillation material comprises: at least one selection from a group consisting of BaO and BaF₂, up to molar 40%; at least one selection from a group consisting of SiO₂ with SiC and SiO₂ without SiC, up to mol. 67%; at least one selection from a group consisting of Gd₂O₃, Lu₂O₃, GdF₃, and LuF₃, up to mol. 58%; and at least one selection from a group consisting of CeO₂ and CeF3, up to 20% from an amount of BaO, BaF₂, Gd₂O₃, Lu₂O₃, GdF₃, and/or LuF₃ present in the scintillation material.

12. The method according to claim 10, wherein the scintillation material comprises: at least one selection from a group consisting of BaO and BaF₂, up to molar 40%; at least one selection from a group consisting of SiO₂ with SiC and SiO₂ without SiC, up to mol. 67%; at least one selection from a group consisting of Gd₂O₃, Lu₂O₃, GdF₃, and LuF₃, up to mol. 58%; at least one selection from a group consisting of Al₂O₃ and AlF₃, up to 20%; and at least one selection from a group consisting of CeO₂ and CeF3, up to 20% from an amount of BaO, BaF₂, Gd₂O₃, Lu₂O₃, GdF₃, and/or LuF₃ present in the scintillation material.

13. The method according to claim 10, wherein the scintillation material comprises: at least one selection from a group consisting of BaO and BaF₂, up to molar 40%; at least one selection from a group consisting of SiO₂ with SiC and SiO₂ without SiC, up to mol. 67%; at least one selection from a group consisting of Gd₂O₃, Lu₂O₃, GdF₃, and LuF₃, up to mol. 58%; at least one selection from a group consisting of Li₂O and LiF, up to 20%; and at least one selection from a group consisting of CeO₂ and CeF3, up to 20% from an amount of BaO, BaF₂, Gd₂O₃, Lu₂O₃, GdF₃, and/or LuF₃ present in the scintillation material.

14. The method according to claim 10, further comprising counting pulses of at least one of electric current and voltage using the processor to estimate the property.

15. The method according to claim 14, further comprising comparing the counted pulses to a reference to estimate the property.

16. A method for producing an apparatus for estimating a property of an earth formation penetrated by a borehole, the method comprising:
producing a scintillation material by heating a mixture of a barium silicate glass transparent to light and doped with Ce and rare earth ions of elements with atomic numbers greater than or equal to 55 according to a temperature profile of temperature versus time, the temperature profile comprising (a) a first stage having a first plateau at a vitrification temperature (T_{g}) of the mixture followed by a second plateau at a temperature (T_{P}) higher than T_{g} but lower than the avalanche crystallization temperature of the barium silicate glass and (b) a second stage following the first stage at a room temperature and having a third plateau at a temperature (T_{C}) that is higher than T_{g} but lower than the avalanche crystallization temperature of the barium silicate glass to produce a barium silicate glass and/or glass ceramic, the scintillation material having a density greater than 4.5 g/cm³;
incorporating the scintillation material into a gamma-ray detector;
optically coupling a photodetector to the scintillation material, the photodetector configured to detect light photons emitted from scintillation of the scintillation material and to provide a signal correlated to the detected light photons;
coupling the photodetector to a processor configured to estimate the property using the signal; and
coupling the gamma-ray detector to a carrier configured to be conveyed through the borehole.

17. The method according to claim 16, wherein the ions of elements with atomic numbers greater than or equal to 55 comprise rare earth ions Gd3+ and/or Lu3+ and the barium silicate glass or glass ceramic comprises (i) scintillation nano-crystallites comprising the rare earth ions Gd3+ and/or Lu3+ and the Ce in structured crystal positions, (ii) non-scintillation nano-crystallites comprising the rare earth ions Gd3+ and/or Lu3+ and the Ce in structured crystal positions, and (iii) the Ce disposed in the barium silicate glass or glass ceramic in non-crystallite form.

18. The method according to claim 17, wherein the mixture comprises: at least one selection from a group consisting of BaO and BaF₂, up to molar 40%; at least one selection from a group consisting of SiO₂ with SiC and SiO₂ without SiC, up to mol. 67%; at least one selection from a group consisting of Gd₂O₃, Lu₂O₃, GdF₃, and LuF₃, up to mol. 58%; and at least one selection from a group consisting of CeO₂ and CeF3, up to 20% from an amount of BaO, BaF₂, Gd₂O₃, Lu₂O₃, GdF₃, and/or LuF₃ present in the scintillation material.

19. The method according to claim 17, wherein the mixture comprises: at least one selection from a group consisting of BaO and BaF₂, up to molar 40%; at least one selection from a group consisting of SiO₂ with SiC and SiO₂ without SiC, up to mol. 67%; at least one selection from a group consisting of Gd₂O₃, Lu₂O₃, GdF₃, and LuF₃, up to mol. 58%; at least one selection from a group consisting of Al₂O₃ and AlF₃, up to 20%; and at least one selection from a group consisting of CeO₂ and CeF3, up to 20% from an amount of BaO, BaF₂, Gd₂O₃, Lu₂O₃, GdF₃, and/or LuF₃ present in the scintillation material.

20. The method according to claim 17, wherein the mixture comprises: at least one selection from a group consisting of BaO and BaF₂, up to molar 40%; at least one selection from a group consisting of SiO₂ with SiC and SiO₂ without SiC, up to mol. 67%; at least one selection from a group consisting of Gd₂O₃, Lu₂O₃, GdF₃, and LuF₃, up to mol. 58%; at least one selection from a group consisting of Li₂O and LiF, up to 20%; and at least one selection from a group consisting of CeO₂ and CeF3, up to 20% from an amount of BaO, BaF₂, Gd₂O₃, Lu₂O₃, GdF₃, and/or LuF₃ present in the scintillation material.
